(19) United States
(12) Patent Application Publication
(10) Pub. No.: US 2019/0190193 A1
(43) Pub. Date: Jun. 20, 2019

(54) MODULAR ELECTRONIC BUILDING SYSTEMS AND METHODS OF USING THE SAME

(71) Applicant: littleBits Electronics Inc., New York, NY (US)

(72) Inventors: Aya BDEIR, New York, NY (US); Geoffrey LIPMAN, New York, NY (US); Jordi BORRAS, New York, NY (US); Antonio HERNANDEZ, New York, NY (US); Paul ROTHMAN, New York, NY (US)

(21) Appl. No.: 15/845,730

(22) Filed: Dec. 18, 2017

(51) Int. Cl. H01R 13/62; H01R 12/71; H01R 12/70; A63H 33/04

(52) U.S. Cl. CPC H01R 13/6205; A63H 33/042; H01R 12/7005; H01R 12/718

(57) ABSTRACT

In some embodiments, an apparatus includes a first connector that includes a housing that defines a receptacle between a top surface and the bottom surface. The receptacle has a first end open at the top surface and a closed second end opposite the first end, and a magnet is disposed within the receptacle. A circuit board is permanently coupled to the first connector such that a bottom surface of the circuit board contacts the top surface of the housing and the circuit board covers the first end of the receptacle preventing the magnet from being removed from the receptacle. The first connector can be removably coupled to a second connector such that a front surface of the housing of the first connector engages a front surface of a housing of the second connector and the magnet of the first connector magnetically couples to a magnet of the second connector.

### CROSS-REFERENCE TO RELATED APPLICATIONS

This application is related to co-pending U.S. provisional patent application having Attorney Docket No. LIBI-006/00US 317728-2072, filed on the same date as this application, the disclosure of which is incorporated herein by reference in its entirety.

This application is related to U.S. patent application Ser. No. 13/975,923, entitled “Modular Electronic Building Systems with Magnetic Interconnections and Methods of Using the Same,” filed Aug. 26, 2013, which claims priority to and the benefit of U.S. Provisional Patent Application No. 61/728,103, entitled “Modular Electronic Building Systems with Magnetic Interconnections and Methods of Using the Same,” filed Nov. 19, 2012, and is a continuation-in-part of U.S. patent application Ser. No. 13/593,891, entitled “Modular Electronic Building Systems with Magnetic Interconnections and Methods of Using the Same,” filed Aug. 24, 2012, which claims priority to U.S. Provisional Patent Application No. 61/527,860, filed Aug. 26, 2011, each of the disclosures of which is incorporated herein by reference in its entirety.

This application is also related to U.S. patent application Ser. No 15/228,707, entitled “Modular Electronic Building Systems with Magnetic Interconnections and Methods of Using the Same,” filed Aug. 4, 2016, which is a continuation of U.S. patent application Ser. No. 14/696,922, entitled “Modular Electronic Building Systems with Magnetic Interconnections and Methods of Using the Same,” filed Apr. 27, 2015, which is a continuation of U.S. patent application Ser. No. 13/593,891, entitled “Modular Electronic Building Systems with Magnetic Interconnections and Methods of Using the Same,” filed Aug. 24, 2012, which claims priority to and the benefit of U.S. Provisional Patent Application No. 61/527,860, filed Aug. 26, 2011, each of the disclosures of which is incorporated herein by reference in its entirety.

### BACKGROUND

Embodiments are described herein that relate to devices and methods used in the field of electronics and, more particularly, to electronic building blocks and toy building sets.

Some known building block systems can include inter-connectable electronic components that can be used to create various projects, toys and electronic products. Some such systems can be intimidating, time consuming, and demand an expert skill set, as well as specialized hardware/software platforms. This makes building objects with lights, sounds, buttons and other electronic components very difficult and prohibitive to, for example, kids, young students, designers, non-engineers, and others lacking electronics experience. However, as advances in the miniaturization of technology increase, the need for electronics to be more accessible to non-experts in a cost effective manner continues to grow. Some electronic building systems exist that have been simplified to allow users to be able to design and assemble electronic products, objects, items, etc. without specialized skills; with the ever changing technology of electronics and the desire of people to experience new challenges, however, the need for improved electronic building systems continues to increase.

Thus, a need exists for a new and/or improved simple, easy to use, accessible electronic building block system that can enable the design and assembly of complex, interdependent systems. Such a system would enhance learning, enable experimentation and promote innovation. A need also exists for a building block system that can be used in conjunction with and be inter-connectable with other building block systems, and/or to be used or combined with other traditional materials such as paper, cardboard, screws, or other electronic components.

### SUMMARY

In some embodiments, an apparatus includes a first connector that includes a housing having a top surface and a bottom surface opposite the top surface. The housing defines a receptacle between the top surface and the bottom surface of the housing. The receptacle has a first end open at the top surface and a second end opposite the first end that is closed. A magnet is disposed within the receptacle. A circuit board having a top surface and a bottom surface opposite the top surface is permanently coupled to the first connector such that a bottom surface of the circuit board contacts the top surface of the housing of the first connector and the circuit board covers the first end of the receptacle preventing the magnet from being removed from the receptacle. The first connector is configured to be removably coupled to a second connector such that a front surface of the housing of the first connector engages a front surface of a housing of the second connector and the magnet disposed within the receptacle of the housing of the first connector magnetically couples to a magnet of the second connector.

### BRIEF DESCRIPTION OF THE FIGURES

FIG. 1A is a schematic illustration of an electronic building system, according to an embodiment.

FIGS. 1B-1D are each a schematic illustration of a side view of a module of an electronic building system, according to an embodiment, and FIG. 1E is a schematic illustration of a top view of the three modules of FIGS. 1B-1D coupled together.

FIG. 2 is a perspective view of a module of an electronic building system, according to another embodiment.

FIG. 3 is a bottom view of the module shown in FIG. 2.

FIG. 4A is a top view of the module of FIG. 4.

FIG. 4B is a side cross-sectional view of the module of FIG. 4A taken along line 4B-4B in FIG. 4A.

FIG. 5 is an end view of the module of FIG. 3.

FIG. 6 is an opposite end view than FIG. 5 of the module of FIG. 3.

FIG. 7 is a side view of the module of FIG. 3.

FIG. 8 is an opposite side view than FIG. 7 of the module of FIG. 3.

FIG. 9 is a partial exploded view of the module of FIG. 3.

FIG. 10 is a perspective view of a connector of the module of FIG. 3.

FIG. 11 is an exploded perspective view of the connector of FIG. 10.

FIG. 12 is a perspective view of a male connector of the module of FIG. 3 and a female connector of a different module, shown in an uncoupled configuration.

FIG. 13 is a perspective view of the male connector of the module of FIG. 3 and a female connector of a different module, shown in a coupled configuration.

FIG. 14 is a perspective view of the module of FIG. 3 shown coupled to another module of the electronic building system.

FIG. 15 is a perspective view of a module of an electronic building system, according to another embodiment.

FIG. 16 is a bottom perspective view of the module of FIG. 15.

FIG. 17 is a perspective view of the module of FIG. 15 shown coupled to another module of the electronic building system, and each module coupled to a component of a different building block system.

FIG. 18 is a perspective view of two modules of an electronic building system, according to another embodiment, shown coupled together and having color-coded connectors.

FIG. 19 is a perspective view of two modules of an electronic building system, according to another embodiment, shown coupled together and each having an indicator strip disposed on the circuit board of the modules.

FIG. 20 is a perspective view of two modules of an electronic building system, according to another embodiment, shown coupled together and having color-coded fasteners.

FIG. 21 is a side view of a male connector of a first module of an electronic building system, according to another embodiment, and a female connector of the electronic building system, shown uncoupled.

FIG. 22 is a perspective view of the male connector and the female connector of FIG. 21, shown uncoupled

FIG. 23A-23C are each a schematic illustration of a side view of a different embodiment of a module.

### DETAILED DESCRIPTION

In some embodiments, an electronic educational toy or a modular electronic building block system is provided that can teach the logic of programming and circuit building without requiring expertise in either. In some embodiments, the modular electronic building block system (also referred to herein as “system” or “block system” or “electronic building system”) includes modules that include pre-assembled printed circuit boards (PCB) and connectors coupled to the PCB. The connectors can be interconnected using, at least in part, small magnets. Each module (also referred to as a “block”) can perform one or more discrete functions (e.g., an LED, a pushbutton, a light sensor with a threshold, etc.), and the modules can be combined to produce larger circuits. Some modules can respond to external events such as mechanical forces, touch, proximity, radio frequency signals, environmental conditions, etc. Some blocks can have pre-engineered functionalities and some blocks simply pass current like wire blocks. Yet other blocks can provide current, such as, for example, a power module.

In some embodiments, the modules described herein may be divided into categories corresponding to their function. Examples of categories can include, but are not limited to: power modules, input modules, output modules, wire modules, etc. Power modules, for example, can take current from a battery, an AC adapter (e.g., wall wart), or other power source, and convert it into current, feeding the other components of the system. In any working configuration of modules, there may be at least one power module. Input modules can include, but are not limited to: buttons, switches, sensors, etc. Output modules can include, but are not limited to: LEDs, displays, sound modules, motors, etc. In some embodiments, wire modules may not perform a particular function, but act as wire extensions, configuration changers, and in some cases logic and state modules.

In some embodiments, the general electrical operation of the system can include modules that can include a standard interface and communicate automatically when connected. In some embodiments, each module can include three or more electrical lines and such lines are interconnected between and throughout all modules. For example, the electrical lines can each be coupled to one or more conductors of a module. These lines can include, for example, data, power, signal and ground. In some embodiments, a module(s) can have at least three conductors, and includes three electrical lines including a power line, a signal line and a ground line. In some embodiments, power and signal lines of the power modules are at 5 Volts, the system is relatively low power, and the power and ground lines are shared among all the modules. In other exemplary embodiments, the power may be something other than 5 Volts such as, for example, 3V, 9V, 12V, 15V, alternating current (AC), etc. In some embodiments, a power line of a first module of a module system can provide power at a different voltage than a power line of another module of the module system. Input modules can take the incoming signal, and manipulate it according to the module's function, and output the modified signal. In the case of a pressure sensor connected to a power module, for example, the sensor module takes 5 Volts into the signal line, and outputs a voltage between 0 and 5 Volts depending on the amount of pressure applied to the sensor. Output modules respond to the signal line by representing the voltage in light, sound, display, movement or other forms. In some embodiments, the pressure sensor scales the input signal in proportion to the pressure at the sensor, and passes that scaled signal to the output. Output modules transform or transduce incoming signal information into perceivable actions, such as light, sound, motion, or other perceivable actions.

All modules are pre-assembled, pre-engineered, and contain the logic and circuitry used to make the module readily usable. For example, an LED module can contain a resistor corresponding to its current rating, an Operation Amplifier (OpAmp) as a buffer from the remainder of the circuit, or any other appropriate electronic circuitry. In another example, a coin cell battery module can incorporate a discharge protection circuit. In some exemplary embodiments, the system does not require any hardware or software platform. In other exemplary embodiments, the system may include a hardware and/or software platform. In some embodiments, the modules can be programmed. In some embodiments, the modules do not need to be programmed and do not require a central circuit controlling them. In such embodiments, the system can be standalone and does not need a computer or hub. In some embodiments, however, the system may be connected to a device such as a computer, hub, memory storage, or personal electronic mobile device, such as, for example, a cellular phone, smart phone, etc., to access or produce additional functionality or to retrieve information or power from the device.

In some embodiments, an electronic building system as described herein can include logic and state modules that can be used for programming. Such modules can enable a user to program certain behaviors of his/her designed system without needing to learn a programming language, to write code on a computer, or to program a microcontroller circuit. For example, programming can be done through using logic modules to produce decision trees. In some embodiments, microcontroller programming can be done on the system. Also, a module can include feature controls, such as, for example, switches, knobs and buttons that enable selection of modes of behavior. Some modules can allow for the selection of a mode or adjustment of their behavior. For instance, a proximity sensor module can contain a mode switch and a potentiometer. Through the manipulation of the embedded potentiometer, the threshold level can be set, determining the input signal level beyond which the module should output a high. Also, by, for example, flipping a switch, the module can go from normally-high to normally-low, in essence inverting its response to the desired threshold. In some embodiments, this functionality can be implemented in software as well.

In some embodiments, a system as described herein can provide and include multiple electrical modules selectively couplable together to transmit electrical current from one electrical module to another electrical module, each module having at least one functionality associated therewith and including a connector adapted to couple to a connector of another electrical module. When the modules are coupled together (e.g., via the connectors), a functionality of at least one of the electrical modules can be dependent upon at least another one of the electrical modules.

In some embodiments, a system can include one or more modules that can communicate with one another via a wireless communication protocol (e.g., Bluetooth radios). In other words, one or more modules can communicate with each other without being mechanically coupled together.

In some embodiments, a system as described herein can include at least four different categories of modules: power; input; output; and wire; although more types of modules are possible. Power modules provide electricity to the system. Input modules can interpret data or their surroundings and provide that input to the system. Output modules can make visual, physical, or audible changes to their surroundings based on input(s) to the system. Thus, the output modules can produce perceivable sensory or physical events. Wire modules can route power and/or communication between the modules in the system. Wire modules can also modify the electrical signals. Said another way, input modules can transduce real-world perceivable actions into signal information in the system. Output modules can transduce system signal information into real-world perceivable actions, such as light, sound, motion, or other perceivable actions. Wire modules can perform transformations or manipulations upon system signals that do not directly result in perceivable actions or events.

Many different types of modules are possible in each category, including but not limited to the following: (i) power modules, including, for example, wall power modules, battery power modules, solar power modules, discharge protection circuits; (ii) input modules: pulse modules, pressure sensor modules, proximity modules, input recording modules, potentiometer modules, button modules, temperature modules, accelerometer modules, memory modules, timer modules; (iii) output modules, including, for example, motion modules, motor modules, vibration motor modules, fan modules, RGB LED modules, LED modules, bar graph modules, speaker modules, display modules such as, organic light emitting diodes (OLED) modules, or liquid crystal display (LCD) modules, and electroluminescent wire modules; and (iv) wire modules, including, for example, wire modules of various lengths, extender modules, splitter modules, programmable microcontroller unit (MCU) modules, and interface modules. Any known type of circuit or electronic component or combination of components may be used to create a module and thus form a portion of a system built using such components.

In some embodiments, when a first power module is connected to a second module, the power signal from the power module is transferred from the power module to the second module. Accordingly, the second module is powered by the first module. If, for example, a button module, sensor module, or other type of module is placed somewhere between the first power module and a second module, the signal or current may be affected by the action of the button module or the sensor module. For example, the signal or current may not pass (or, alternatively, may continuously pass) from the first module (power module) to the second module unless the button on the button module is depressed or the sensor on the sensor module is activated. Similarly, if a sensor module is only partially activated, then only partial current is transferred from the first module (power module) to the second module.

The modules described herein may be provided as individual modules or provided as part of a set or kit. A kit can include, for example, standard module components as well as specialized components such as sensor sets, mechanical sets, biological sets, sound sets, etc.

According to some embodiments, a kit that can include at least a portion of a building block system having multiple modules as well other supporting components, such as, for example, accessory components to allow a user to build a particular electronic device, such as, for example, a lamp, a toy vehicle, a light switch dimmer, etc. In some embodiments a kit may include one or more different category of modules (power, input, output, and/or wire), one or more different types of each category of modules, a container in which to store the modules, a mounting board or substrate upon which to place or couple modules, learning materials, accessories, instructions, or a variety of other components. For example, a kit may include multiple modules that may be connected in an almost unlimited number of combinations to perform numerous different input and output functions. In other exemplary embodiments, the kit may also include a limited number of modules that are intended to be assembled in a limited number of combinations, including a single combination, to perform a limited number of functions. For example, for a kit intended to be used to build a particular functional system, the kit can include as many as tens or hundreds or more modules, or it can include just two modules (a power module and an output module). In some embodiments, a kit may include modules and components intended to augment an existing module library or existing kit, in which case it may include just one type of module, such as, for example, a kit of only wire modules or only output modules. A kit may also be directed to a certain age group, with a kit for an elementary level including fewer and/or less complicated modules than a kit designed for a high school level, for example. In some embodiments, a kit may include instructions, videos, or other means, which inform the user as to one or more possible combinations of the modules. For example, the instructions may instruct the user how to assemble the modules into a battery-powered motion sensor that emits an audible alarm upon detection of movement.

In some embodiments, a system can be adapted to give access to sophisticated devices through, for example, analog or other interfaces. Example complex devices may include, but are not limited to, LCD displays, OLED screens, timers, accelerometers, logic gates, and many more. In some embodiments, this may be accomplished by pre-engineering one or more modules and providing “entry points” into the devices. The entry points can be, for example, knobs or switches that allow the user to adjust the intensity or frequency of pulsing, change modes of operation, set thresholds, make decisions, or remember a configuration, among many other operations. These may be considered “entry points” because they are based on similar devices that people know how to use from their everyday lives. The example modular systems described herein may take lessons and iconography from consumer electronics (such as, for example, blenders, DVD players, alarm clocks, game consoles) and apply them to these semi-raw electronic modules.

An example entry point module may include an OLED screen module, which includes an SD card slot in which users can insert an SD card preloaded with images and video. Images and videos may also be provided by a connected edge-router module and sent to another module via a digital communication protocol. The OLED screen module may also include a microcontroller on-board, which is pre-programmed with firmware to access and display the images. Also integrated in the OLED screen module may be a toggle switch and a knob, where the toggle switch selects between fixed images/video or looping and the knob adjusts the looping speed. In the above example, even though the circuit board and firmware itself may be complex, the end result will be an easy-to-use OLED screen module with appropriate iconography that may be accessible to children and novice users alike. The exemplary system may allow for and include the pre-engineering and design of numerous other complex modules similar to the OLED screen example.

In some embodiments, an apparatus includes a first connector that includes a housing having a top surface and a bottom surface opposite the top surface. The housing defines a receptacle between the top surface and the bottom surface of the housing. The receptacle has a first end open at the top surface and a second end opposite the first end that is closed. A magnet is disposed within the receptacle. A circuit board having a top surface and a bottom surface opposite the top surface is permanently coupled to the first connector such that a bottom surface of the circuit board contacts the top surface of the housing of the first connector and the circuit board covers the first end of the receptacle preventing the magnet from being removed from the receptacle. The first connector is configured to be removably coupled to a second connector such that a front surface of the housing of the first connector engages a front surface of a housing of the second connector and the magnet disposed within the receptacle of the housing of the first connector magnetically couples to a magnet of the second connector.

In some embodiments, an apparatus includes a first connector including a housing having a top surface and a bottom surface opposite the top surface, and a contact assembly coupled to the first connector. A first circuit board having a top surface and a bottom surface opposite the top surface, is coupled to the first connector such that the bottom surface of the first circuit board contacts the top surface of the housing of the first connector and at least a portion of the contact assembly is disposed between the bottom surface of the first circuit board and a portion of the housing of the first connector. The first connector can be removably coupled to a second connector such that a front surface of the housing of the first connector engages a front surface of a housing of the second connector and at least a portion of the contact assembly is received within an interior region defined between the housing of the second connector and a second circuit board coupled to the housing of the second connector, and at least one contact of the contact assembly electrically and directly engages at least one contact of the second circuit board.

In some embodiments, an apparatus includes a first connector including a first housing having a top surface and a bottom surface opposite the top surface and a contact assembly permanently coupled to the first housing of the first connector. A first circuit board having a top surface and a bottom surface opposite the top surface is permanently coupled to the first connector such that at least a portion of the bottom surface of the first circuit board contacts at least a portion of the top surface of the first housing of the first connector and at least a portion of the contact assembly is disposed between the bottom surface of the first circuit board and at least a portion of the first housing. The apparatus further includes a second connector that includes a second housing having a top surface and a bottom surface opposite the top surface of the second housing. The first circuit board is permanently coupled to the second housing of the second connector such that an interior region is defined between a portion of the bottom surface of the first circuit board and a portion of the second housing of the second connector. The contact assembly of the first connector configured to be received within an interior region defined between a third connector and a second circuit board coupled to the third connector. The interior region defined between the second housing of the second connector and the second circuit board can receive a portion of a contact assembly coupled to a fourth connector and to a third circuit board coupled to the fourth connector.

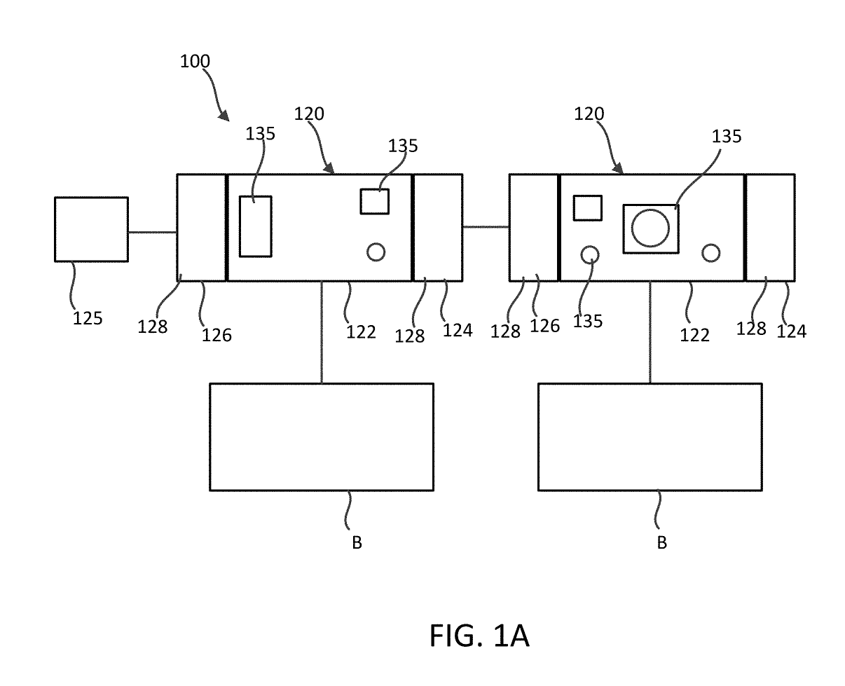

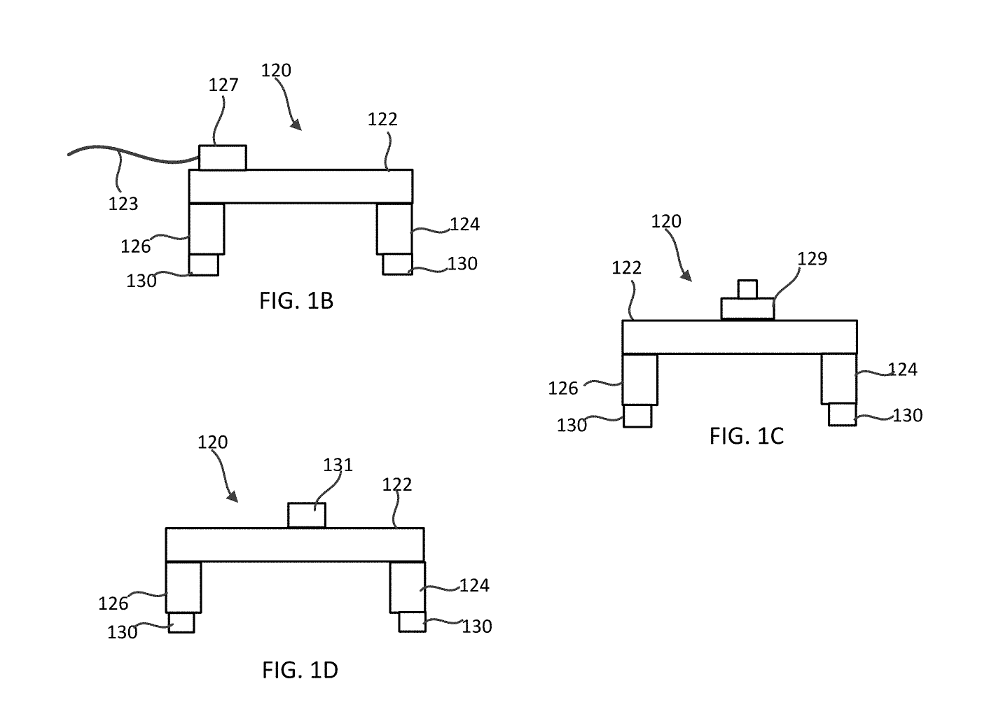

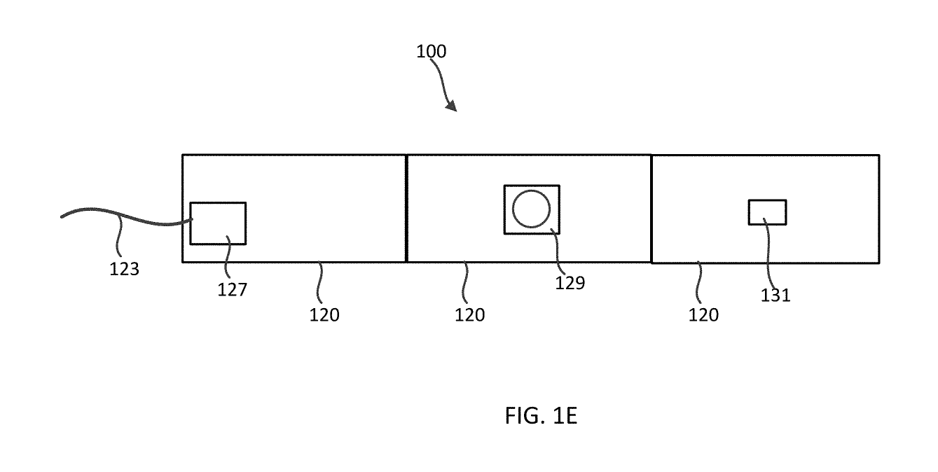

Referring now to the figures, FIG. 1A is a schematic illustration of a modular electronic building block system, according to an embodiment, FIGS. 1B-1D each illustrate an example of a different module 120, and FIG. 1E illustrates the modules of FIGS. 1B-1D coupled together. The modular electronic building block system 100 (also referred to herein as “system”, “block system” or “electronic building block system” or “electronic building system”) can include one or more electronic modules 120 (also referred to herein as “modules,” “blocks,” or “electronic blocks”) that can each be removably coupled to at least one other module 120. FIG. 1A illustrates two modules 120. Each module 120 can include a printed circuit board 122 (also referred to as “PCB” or “circuit board”) coupled to two or more connectors, such as connectors 124 and 126, shown in FIG. 1A. The circuit board 122 can include various associated electronic or electrical components to perform various desired functions. The circuit board 122 can also include at least two interfaces (e.g., an input interface and an output interface). In some embodiments, the circuit board 122 can include, for example, two input interfaces and two output interfaces. Although the circuit board 122 is shown having a particular length and width, it should be understood that the circuit board 122 can have different lengths and widths than the example embodiments shown and described. It should also be understood that although the circuit board 122 is shown as being rectangular, the circuit board 122 can alternatively be a variety of different shapes, e.g., square, triangular, etc.

The connectors 124 and 126 can each include a housing 128 that can be fixedly or permanently coupled to the circuit board 122 with, for example, a mechanical fastener (e.g., bolt, screw, rivet, etc.). In other embodiments, the connectors can be coupled to the circuit board with a friction fit, and in yet other embodiments, the connectors can be coupled to the circuit board with a spring-loaded mechanism. As shown in the schematic illustrations of FIGS. 1B-1D, the circuit board 122 is coupled to the connectors 124 and 126 such that a bottom surface of the circuit board contacts a top surface of the connectors 124 and 126. Thus, the circuit board 122 is disposed over the connectors 124 and 126. In some embodiments, when the circuit board 122 is coupled to the connectors 124, 126, a front surface of the circuit board 122 is aligned or substantially aligned with a front surface of the connectors 124, 126, and/or a side surface of the circuit board 122 is aligned or substantially aligned with a side surface of the connectors 124, 126.

The housing 128 can be the same or substantially the same form factor for both connectors 124 and 126 as described in more detail below. In other words, the connector 124 and the connector 126 each include the same or common housing 128. In alternative embodiments, the connectors 124 and 126 can each include a different housing 128. The housing 128 can be, for example, formed with an appropriate plastic material and be injection molded. The housing 128 can be a single injection molded component or can include multiple components coupled together (e.g., with ultrasonic welding, friction fit, or with fasteners). The housing 128 can define one or more receptacles (not shown in FIG. 1A) that can receive therein a magnet that can be used to removably couple a connector (e.g., 124) of one module 120 to a connector (e.g., 126) of another module 120 as described in more detail below. The receptacles can have an open end at a top surface portion of the housing 128 and a closed bottom end. Thus, when a magnet is disposed within the receptacle, the magnet can rest on a bottom surface at the closed end of the receptacle.

The magnets on one connector (e.g., 124) of a module 120 can have the north face of the magnet(s) facing out and the other connector (e.g., 126) of the module 120 can have the south face of the magnet(s) facing out. The south facing side of the connector of one module 120 can only be coupled to the north facing side of a connector on another module 120. This ensures proper connection and appropriate polarity for the electronic circuit/PCB of the modules. The repelling polarities inhibit the magnets from one connector (e.g., 124, 126) connecting to another connector (e.g., 124, 126) in an inappropriate manner to facilitate the electrical connection of the modules 120 in the correct manner. For example, a connector with a magnet with the north face of the magnet facing outward cannot be coupled to another connector with a magnet with the north face of the magnet facing outward.

In some embodiments, the connectors (e.g., 124, 126) of a module 120 can also include an interlocking coupling mechanism (not shown in FIGS. 1A-1E) that includes a protrusion and a recess defined by the housing 128 that can interlock, mate or complimentarily fit with a recess and protrusion, respectively, of another connector of another module 120. The interlocking of the protrusions and recesses can inhibit the modules 120 from sliding laterally or side-to-side with respect to each other when removably coupled together. Thus, a connector of one module can be coupled to a connector of another module with the magnets and/or the interlocking coupling mechanism. When a first module 120 is removably coupled to a second module 120 via the magnets of the connectors 124, 126, a front surface of the connector of the first module 120 contacts a front surface of the connector of the second module. In some embodiments, when a first module 120 is removably coupled to a second module 120 via the magnets of the connectors 124, 126, a side surface of the connector of the first module 120 can be aligned with a side surface of the connector of the second module 120.

The modules 120 further include a contact assembly (not shown in FIGS. 1A-1E) that can be coupled to the connector 124 and to the circuit board 122. The contact assembly can include a base with multiple electrical contacts or conductors coupled to the base. For example, in some embodiments, the contact assembly can have from 2-15 contacts, or any suitable number of contacts. The electrical contacts or conductors can be, for example, spring probes or small metal plate. In some embodiments, the electrical contacts can be coupled to the base with soldering; in other embodiments, the electrical contacts can be coupled to the base without soldering, with for example, mechanical couplings or by engagement of the contacts with the base. Further, in some embodiments, the contact assembly is permanently or fixedly connected to the connector 124 and to the circuit board 122 without the use of a solder connection between contacts of the contact assembly and the circuit board or housing 128 of the connector 124. For example, the contact assembly is sandwiched between the housing 128 of connector 124 and the circuit board 122 when the circuit board 122 is coupled to the housing 128 with mechanical fasteners. In some embodiments, the circuit board 122 is permanently coupled to the housing 128 of the connector 124 such that the contact assembly is maintained permanently or fixedly coupled to the connector 124 with a pressure fit. When the module 120 is assembled, with the circuit board 122 coupled to the connectors 124, 126 and the contact assembly permanently or fixedly coupled between the circuit board 122 and the connector 124, a portion of the contact assembly extends outwardly from a front surface of the connector 124 and a front surface of the circuit board 122. The portion extending outwardly can be received within a mating opening of another connector 126 as described in more detail below.

The connector 126 of the module 120 does not include a contact assembly permanently or fixedly connected thereto. Thus, a given module can have a connector 124 with a contact assembly permanently or fixedly coupled thereto and a connector 126 without a contact assembly permanently or fixedly coupled thereto. For the connector 126, when the circuit board 122 is coupled to the connector 126, a front opening and interior region is defined between the circuit board 122 and the connector 126 when viewed from a front end of the module. When a first module 120 is removably coupled to a second module 120 by coupling a connector 124 of the first module to a connector 126 of the second module 120, the portion of the contact assembly extending outwardly from the front surface of the connector 124 can be received in a lateral direction within the interior region defined between the housing 128 of the connector 126 and the circuit board 122 of the second module, and the contacts of the contact assembly of the first module 120 engage the circuit board 122 of the second module.

The magnets of a connector 124, 126 act as magnetically polarizing and mechanically connecting elements, whereas the contact assembly carries an electronic signal from one circuit board 122 to the next circuit board 122 through the mating of the connectors (e.g., 124, 126). In some embodiments, a connector 124 with a contact assembly coupled thereto can be referred to as a male connector, and the corresponding connector 126 that defines an opening to receive a portion of the contact assembly of the male connector can be referred to as a female connector. As described above, the circuit board 122 can include an input interface and an output interface, and the circuit board 122 can be coupled to the connectors 124 and 126 such that one of the connectors 124, 126 is near the input interface of the circuit board 122, and the other connector 124, 126 is near the output interface. Thus, for example, when a first module 120 is coupled to a second module 120, the connector near the output interface of the first module 120 can be coupled to a connector near the input interface of the second module 120 such that electrical current can be carried or transferred from the first module 120 to the second module 120 via the contact assembly, and transferred to a third module 120 coupled to the second module 120 via the input interface of the second module to the output interface of the second module 120 and then to the input interface of the third module 120. In some embodiments, multiple magnets having alternating or identical polarities can also be used in the manner described above.

The modules 120 can also be used or interconnected with components or blocks B of different interlocking building block systems. For example, each module 120 can be coupled to a component or block B of a LEGO® block system. More specifically, each connector 124, 126 can include one or more mounting portion 130 (e.g., see FIGS. 1B-1D) that can matingly couple to such a component B of a different building block system. As shown in FIGS. 1B-1E, the mounting portions 130 extend from a bottom portion of the connectors 124, 126 such that the module 120 can be removably coupled to a top portion of a component B. Further details of such mounting portions 130 are described below with reference to specific embodiments.

Each module 120 can also include one or more electrical or electronic components 135 that can perform a particular function. Example electrical components 135 can include, power components (e.g., various type of batteries, power adapters), sensors (e.g., pressure, temperature), switches, push buttons, knobs, potentiometers, mode switches, tactile switch, timers, speakers, and other audio related components, visual components such as light components (e.g., light emitting diodes (LEDs)), recorders, motors, fans, thermometers, etc. In some embodiments, a module 120 can include, for example, a processor, micro-processor, controller, micro-controller, firmware, or a display such as a digital display. The various electrical or electronic components can be coupled (e.g., soldered) to the circuit board 122 of a module 120. Electrical power can be provided to the electrical components 135 via a power module (described below) and via the contact assemblies and circuit boards 122 of the modules 120 as described above.

As described above, various categories and types of modules 120 can also be referred to by the particular functionality the module provides. For example, a power module, a light module, a sensor module, a switch module, etc. As described above, in some embodiments, a system 100 can include at least four different categories of modules: power; input; output; and wire; although more types of modules are possible. Power modules provide electricity to the system. Input modules can interpret data or their surroundings and provide that input to the system. Output modules can make visual, physical, or audible changes to their surroundings based on signals present in the system. Wire modules can route or modify power, signals and/or communications between the modules in the system, and/or interface with other systems, such as, e.g., the MIDI protocol, a digital display, dot matrix display or video display.

In one example, a power module 120 provides power components and can take current from a battery, an AC adapter (e.g., wall wart), or AC to DC converter, or other power source, and convert it into current, feeding the other components of the system (e.g., other electrical components of the modules coupled to the power module). Thus, in any working configuration of modules (e.g., multiple modules removably coupled together to create a desired functionality), there is typically at least one power module to supply power to the desired system. In some embodiments, some or all of the modules can include a power source. An example power module 120 is shown in the schematic illustration of FIG. 1B and can include, a power adapter 127 with a cord 123 that can be releasably coupled to a power source PS (shown in FIG. 1A). In other embodiments, a power module can include a battery block that can receive one or more batteries, a coin battery, a rechargeable battery (e.g., Lithium-Ion (L-Ion) battery or Lithium Polymer (LiPo) battery), or other type of power source within the power module itself.

FIG. 1C illustrates another example module. A tactile switch module 120 can include a push button 129 (or other type of switch) that can be coupled (e.g., soldered) onto the circuit board 122 as shown in FIG. 1C. As described above, the circuit board 122 can have an input interface and an output interface. The tactile switch module can have, for example, a connector 126 near the input interface and a connector 124 near the output interface. The connector 126 of the tactile switch module 120 can be designed to couple with a connector near an output interface of another module 120, and the connector 124 of the tactile switch module 120 can be designed to couple to a connector near the input interface of a different module. The tactile switch module 120 can include electrical conductors designed to complete connections between two engaging interfaces for a power line and a ground line. A signal line can go through the push button 129, which makes or breaks the circuit, and thus transfers a modified signal line to the output interface corresponding to the module function.

In another example, a light emitting diode (LED) module 120 is shown in the schematic illustration of FIG. 1D. The LED module can include, for example, a LED component 131 (e.g., a dip package LED component) coupled (e.g., soldered) to the circuit board 122. In yet another example, a sound generator module (not shown) can include a speaker, alarm, buzzer, or other sound emitting component. When, for example, the power module of FIG. 1B is coupled to the tactile switch module of FIG. 1C and the tactile switch module is coupled to the LED module as shown in FIG. 1E, and the power module is connected to a power source, when a user pushes the push button of the switch module, a circuit is completed and the LED illuminates. The power module adapter 127 delivers power to the power module and the pre-integrated circuitry in the power module then converts the voltage to a desired voltage such as, for example, 5 Volts in the present example. If the tactile switch module is removed from between the two other modules, the LED module can be coupled directly to the power module and constant power will be delivered to the LED module and the LED will remain illuminated until the power is terminated. In the above-described example, there is one power module, one input module (the tactile switch module) and one output module (the LED module). It should be understood that this is merely one example of the various types of modules that can be coupled together to achieve a particular functionality. In other examples, the LED module could be replaced with an audio module (e.g., a buzzer module) so that when the push button of the tactile switch module is pressed, the audio module makes an audible sound (a buzzer). Many other combinations and sub-combinations are possible with different modules having different functionality all forming different circuits, with immediate response of the elements, and without any need for programming, soldering or circuit assembly.

In some embodiments, input (e.g., user input) need not be limited to just a mechanical input device (e.g., a mechanical switch) but also can be digital input. For example, in some embodiments, a module can have a wireless receiver, and in such an embodiment, a user can use a processor with a wireless transmitter to send a wireless signal to make an input.

In another example module (not shown), a power module can include a battery component, such as, for example, a coin cell battery block. The coin battery can deliver a little over 3 Volts stepped up to 5 Volts by the electronic circuit of the module. The circuit can also include a discharge protection circuit, which demonstrates an example of how the electronic building system can be designed to make the system easier to use and safe for users. The circuit may also include an embedded switch that enables a user to turn on or off the battery component so as not to waste battery power. Connected to the battery module can be a pressure sensor module, which can read the amount of pressure applied to a pressure sensor component and output voltage in the range of, for example, 0 to 5 Volts depending on the amount of pressure applied. As more pressure is applied to the pressure sensor component, higher voltage transmits to the next modules. In this example, the next modules can be, for example, a vibrating motor module and an LED module, which respectively vibrate more and illuminate brighter as the applied pressure increases. It should be understood that the above example of 0-5 Volts is merely an example, and that other voltage ranges can be used to accomplish the electronic functions described.

In some embodiments, each module 120 can include control and protection circuitry to facilitate safe and easy operation of the module 120. In some embodiments, each module 120 can include an operational amplifier component or other electronic circuits used in a buffer configuration to reduce the amount of overall current consumption on the overall system of coupled modules 120. This assists with facilitating the cascading of multiple modules 120 without significant loss of power, as well as scaling the system as may be desired. In other exemplary embodiments, the system 100 may include a booster module in the overall system of coupled modules to boost the current and/or power traveling through the power lines and ensure proper functioning of all the modules 120 in the system 100.

In another example, a user can program behavior of a circuit by manipulating physical elements. In an example embodiment, a power module can include a 9 Volt battery, which module can be coupled to a temperature sensor module that includes a threshold component, and the temperature sensor module can be coupled to an audio module. In this example, the temperature sensor module may be more advanced than a traditional sensor module and can include a temperature sensor and a potentiometer that may be adjusted to set a temperature threshold. If the temperature detected by the temperature sensor is above the set temperature threshold, the temperature sensor module outputs a high reading. This is an example of integrating logic with a simpler analog module to enable complex circuit configurations. An output of a high reading from the temperature sensor module will cause the audio module to activate and a speaker on the audio module to play a pre-recorded message associated with a high reading. For example, this exemplary circuit could be used by a person wishing to have an alarm to turn on the air conditioning. When the temperature exceeds a pre-set threshold temperature, the audio module could play back a message “time to turn on the AC!” Also, the audio module may instead be replaced with, for example, a fan module, which may activate a fan upon receiving a high temperature reading signal from the temperature sensor module.

In some embodiments, the temperature sensor module may incorporate a mode switch that can change the behavior of the module from ‘normally-low’ to ‘normally-high’. In contrast to the above described configuration (which was normally-low), a ‘normally-high’ setting would cause the temperature module to output a high reading except when the temperature exceeds the threshold. This means the audio module would be playing recurrently until the room gets warmer, at which point the audio module will cease to output audio. These controls, in addition to pre-programmed modules, logic modules and state modules, can allow the system to enable complex prototypes and circuits with no programming or electronics knowledge.

Each module 120 of a system 100 may also be uniquely configured to provide a quick visual indication to a user of each module's function. The modules 120 may be uniquely configured in any manner and have any characteristic to identify the functionality of the modules. Additionally, any portion of the module 120 may be uniquely configured and have any characteristic to represent the unique configuration feature. For example, the modules may have a characteristic that uniquely identifies the modules by color-coding, patterning, or may include unique structuring such as shapes, housings, interconnection or couplings, etc. In one example, the connectors of a module can be color-coded as the manner of uniquely configuring modules to provide visual indicators as to the function of the modules. It should be understood, however, that color-coding the connectors of a module 120 is not intended to be limiting and the modules 120 may be uniquely configured in any manner. Color-coding of the modules can provide a user with a quick visual confirmation of the type of module, the functionality of the module, as well as allowing the user to learn which color combinations are possible. The functionality of the modules identified by the unique configurations and characteristics may be any type or level of functionality. For example, the unique configurations may indicate that the modules are input modules, power modules, wire modules, output modules, etc. In other examples, the unique configurations of the modules may be more specific such as, for example, an LED module, a 9-volt battery module, a cell battery module, a potentiometer module, a switch module, a pressure sensor module, a pulse module, a button module, a vibration motor module, a wire module, etc.

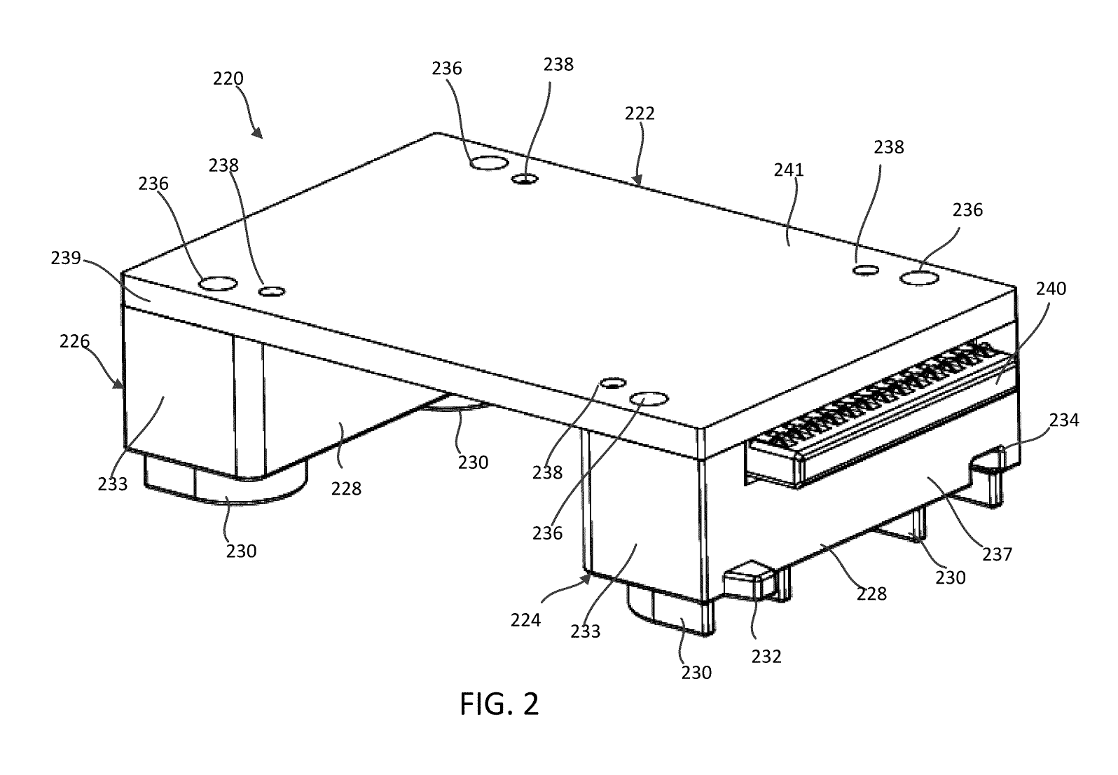

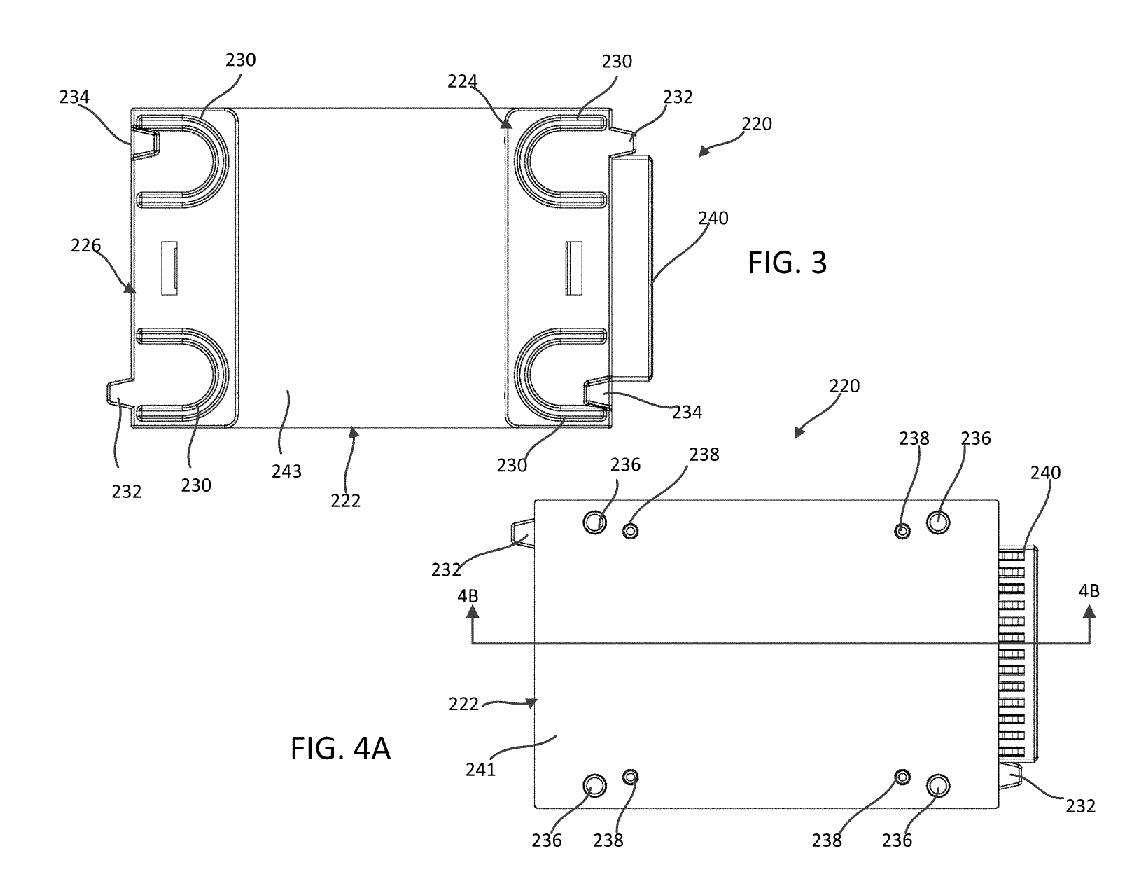

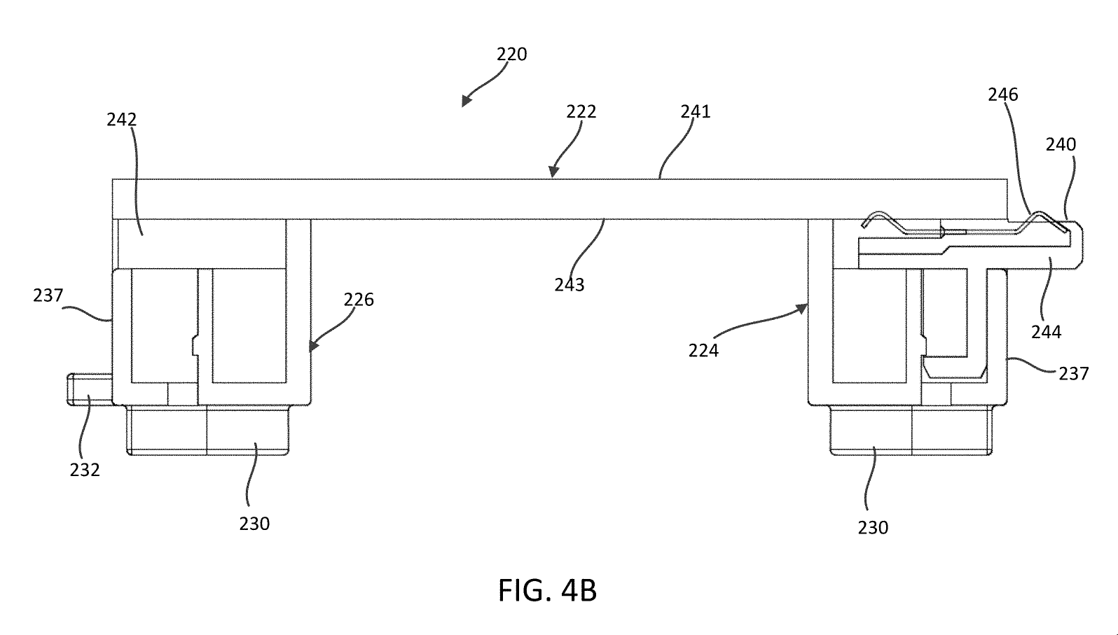

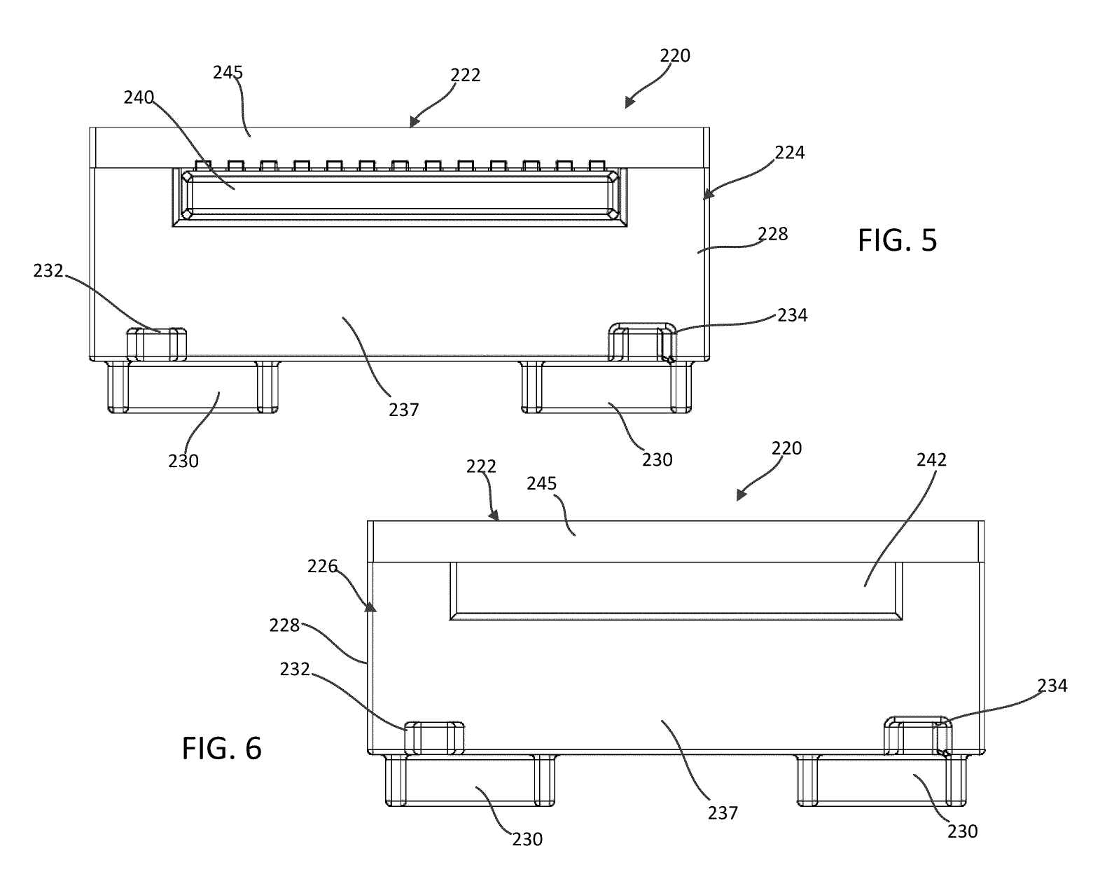

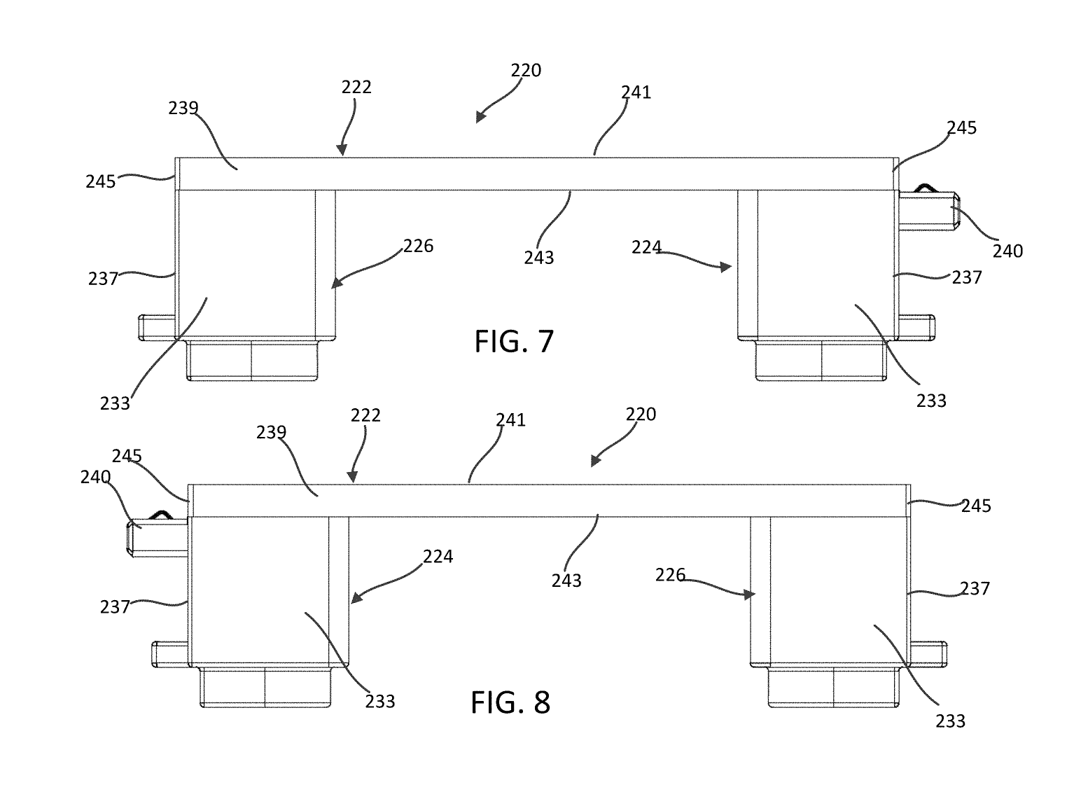

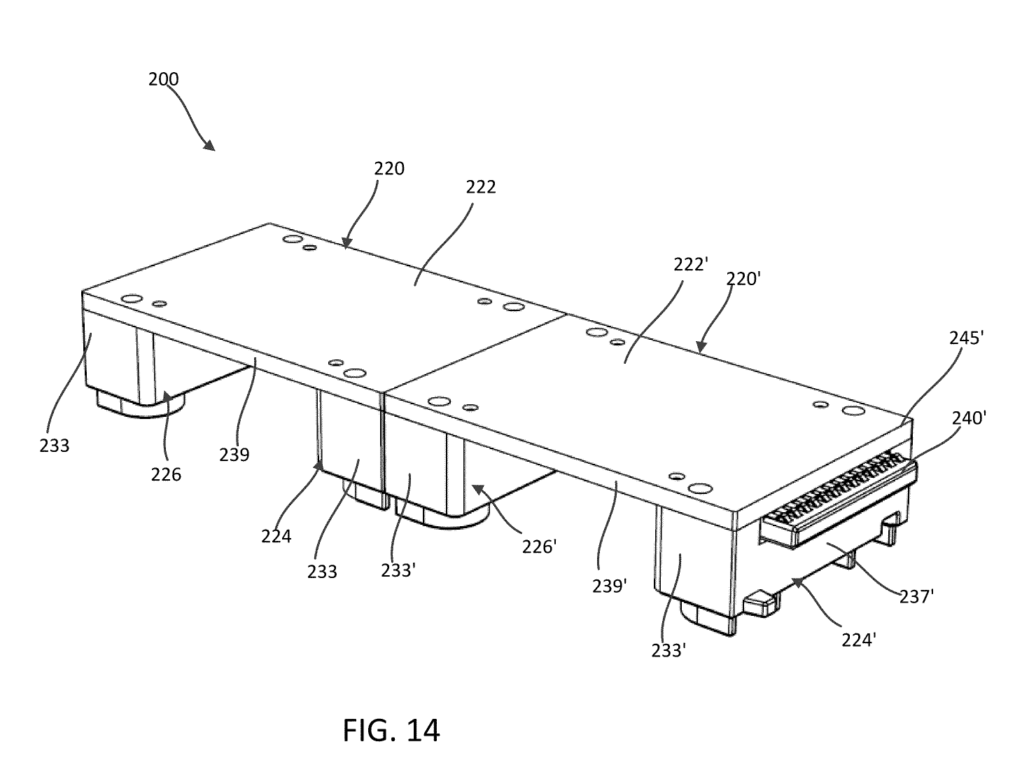

FIGS. 2-14 illustrate components of another embodiment of a modular electronic building system. A modular electronic building block system 200 (also referred to herein as “system”, “block system” or “electronic building block system” or “electronic building system”) can include one or more electronic modules 220 (also referred to herein as “modules,” “blocks,” or “electronic blocks”) that can each be removably coupled to at least one other module 220 (see FIG. 14 illustrating two modules 220 coupled together).

A single module 220 is described with respect to FIGS. 2-13, but it should be understood that other modules of the system 200 can have the same or similar components and be coupled to another module in the same manner as described for module 220. Further, although not shown in FIGS. 2-14, the modules 220 of the system 200 can each include one or more electrical components (e.g., electrical components 135) as described above for system 100 that can each provide a module 220 with a particular functionality, and include various categories and types of modules as described above. For example, the system 200 can include a power module 220 and when the power module 220 is removably coupled to another module 220 having an electrical component, the power module 220 can provide power to that other module 220 (and its electrical component). The electrical component(s) can be, for example, coupled to the circuit board 222 (e.g., to a top surface 241 of the circuit board 222).

The module 220 includes a printed circuit board 222 (also referred to as “PCB” or “circuit board”) coupled to a first connector 224 and a second connector 226. The circuit board 222 can include various associated electronic or electrical components to perform various desired functions, and include an input interface and an output interface. The circuit board 222 can also have various lengths and widths than those shown with respect to FIGS. 2-14.

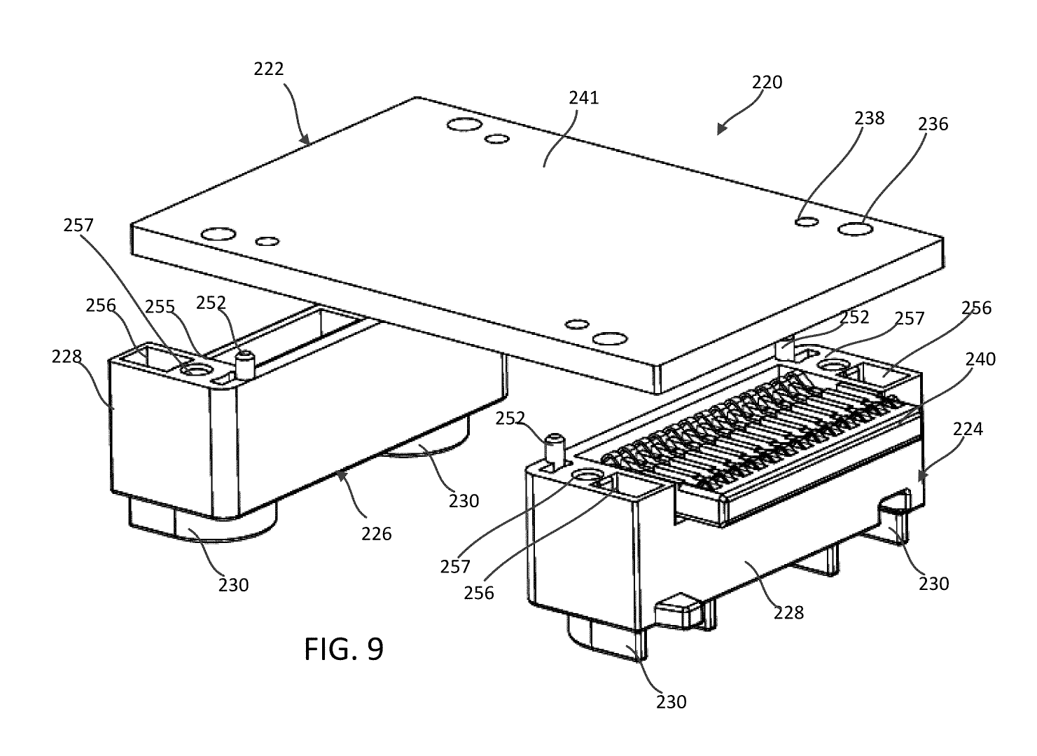

The connectors 224 and 226 each include a common housing 228 (i.e., same shape and size) that can be fixedly or permanently coupled to the circuit board 222 with, for example, a mechanical fastener (e.g., bolt, screw, rivet, etc.) (not shown). For example, the circuit board 222 includes or defines openings 236 and the connectors 224 and 226 can each define corresponding openings 257 (see e.g., FIGS. 9-13) that can receive a fastener (not shown) therethrough to secure the circuit board 222 to the connectors 224 and 226. The circuit board 222 also defines openings 238 that can receive a locating pin 252 of the connectors 224 and 226 (see e.g., FIGS. 9-13). The locating pins 252 can help position the circuit board 222 during assembly.

As described above for the previous embodiment, the circuit board 222 is coupled to the connectors 224 and 226 such that a bottom surface 243 of the circuit board 222 contacts a top surface 255 of the housing 228 of the connectors 224 and 226. When coupled to the circuit board 222, the connectors 224 and 226 are disposed below or beneath the circuit board 222. In addition, a side surface 239 of the circuit board 222 is aligned or substantially aligned with a side surface 233 of the connectors 224 and 226, and a front or end surface 245 of the circuit board 222 is aligned or substantially aligned with a front surface 237 of the connectors 224 and 226. As described herein, reference to the side surface 233 of the connectors 224 and 226 also refers to a side surface 233 of the common housings 228 of the connectors 224 and 226, and the front surface 233 of the connectors 224 and 226 also refers to a front surface 233 of the common housings 228 of the connectors 224 and 226.

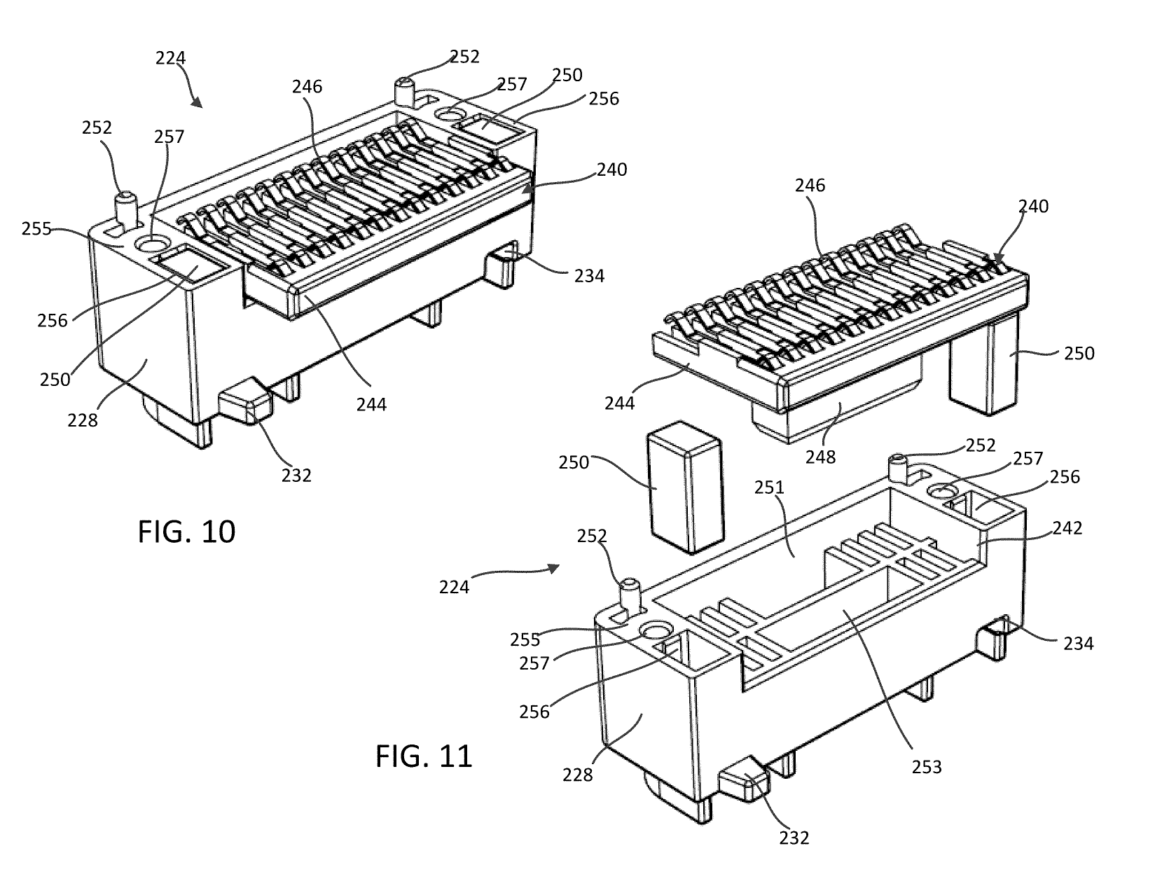

The common housing 228 defines two receptacles 256 (FIGS. 9-13) that can each receive therein a magnet 250 (FIGS. 10-13, magnets 250 are not shown in FIG. 9). The receptacles 256 can have an open end at the top surface 255 of the housing 228 and a closed bottom end. Thus, when a magnet 250 is disposed within a receptacle 256, the magnet 250 can rest on a bottom surface at the closed end of the receptacle 256. The magnets 250 can be used to removably couple each of the connectors 224 and 226 to a connector of a different module 220 of the system 200. For example, with the magnets 250 disposed within the receptacles 256, a magnetic force can be applied/transferred through the front surface 237 of the housing 228 of the connectors 224 and 226. Thus, the connectors 224 and 226 can each be removably coupled to another connector of another module 220 through magnetic force when the front surface 237 of the connectors 224 and 226 engages/contacts a front surface 237 of another connector (similarly constructed with magnets 250 disposed within receptacles 256). In other words, the connectors 224 and 226 will be magnetically coupled to the other connectors via magnetic force of the magnets 250.

As described above, the magnets 250 of one connector (e.g., 224) of the module 220 can have the north face of the magnet(s) facing out and the other connector (e.g., 226) of the module 220 can have the south face of the magnet(s) facing out. The repelling polarities inhibit the magnets 250 from one connector (e.g., 224, 226) connecting to another connector (e.g., 224, 226) in an inappropriate manner to facilitate connecting of the modules in the correct manner. For example, a connector with a magnet 250 with the north face of the magnet facing outward cannot be coupled to another connector with a magnet 250 with the north face of the magnet facing outward.

The connectors 224 and 226 of the module 220 also include an interlocking coupling mechanism that includes a protrusion 232 and a recess 234 defined by the housing 228 that can interlock, mate or complimentarily fit with a recess 234 and protrusion 232, respectively, of another connector of another module 220. The interlocking of the protrusions 232 and recesses 234 can inhibit two modules 220 from sliding laterally or side-to-side with respect to each other when removably coupled together. In this embodiment, the protrusion 232 is spaced laterally apart from the recess 234 as shown, for example, in FIGS. 2, 3, 5, 6, 9 and 12.

The connectors 224, 226 of the module 220 can each be coupled to a different connector of another module 220 with the magnets 250, and the interlocking coupling mechanism (e.g., protrusion 232 and recess 234) can further help maintain the connectors of the different modules coupled together. When the module 220 is removably coupled to another module 220 via the magnets 250 of the connectors 224 or 226, a front surface 237 of the connector 224, 226 of the module 220 contacts a front surface of the connector of the other module 220. For example, as shown in FIG. 14, the module 220 is coupled to a module 220′ such that the front surface of the connector 224 contacts a front surface (not shown in FIG. 14) of the connector 226′ of the module 220′. Further, when the module 220 is removably coupled to another module 220 via the magnets 250 of the connectors 224 or 226, a side surface 233 of the connector 224 or 226 of the module 220 is aligned or substantially aligned with a side surface of the connector of the other module 220. For example, as shown in FIG. 14, the module 220 is removably coupled to the module 220′ and the side surface 233 of connector 224 is aligned with the side surface 233′ of the connector 226′.

The module 220 further includes a contact assembly 240 that is coupled to the connector 224 and to the circuit board 222. The contact assembly 240 includes a base 244 and multiple electrical contacts or conductors 246 coupled to the base 244 as best shown in FIGS. 9-11. The contacts 246 can be, for example, spring probes or small metal plates. In this embodiment, there are 13 contacts 246, but it should be understood that a different number of contacts 246 can be used. The contact assembly 240 also includes a mounting block 248 extending from a bottom surface of the base 244 as shown in FIG. 11. The contact assembly 240 is sandwiched between the housing 228 of connector 224 and the circuit board 222 when the circuit board 222 is coupled to the housing 228 with mechanical fasteners. More specifically, the contact assembly 240 is positioned within a top open region 251 (FIG. 11) of the housing 228, and the mounting block 248 is inserted into an opening 253 defined by the housing 228. The magnets 250 are inserted into the receptacles 256, and the circuit board 222 is permanently coupled to the housing 228 of the connector 224 (via fasteners within openings 236 and 257) such that the contact assembly 240 is maintained permanently coupled to the connector 224 with a pressure fit. The magnets 250 are also maintained within the receptacles 256 with the circuit board 222 coupled to the connectors 224, 226. Thus, the contact assembly 240 and the magnets 250 are permanently coupled to the connector 224 and to the circuit board 222 without the use of a solder connection between contacts 246 of the contact assembly 240 and the circuit board or housing 228. As shown, for example, in FIGS. 2-4B, 7 and 8, when the module 220 is assembled with the circuit board 222 coupled to the connectors 224 and 226, a portion of the contact assembly 240 extends outwardly from the front surface 237 of the housing 228 of connector 224.

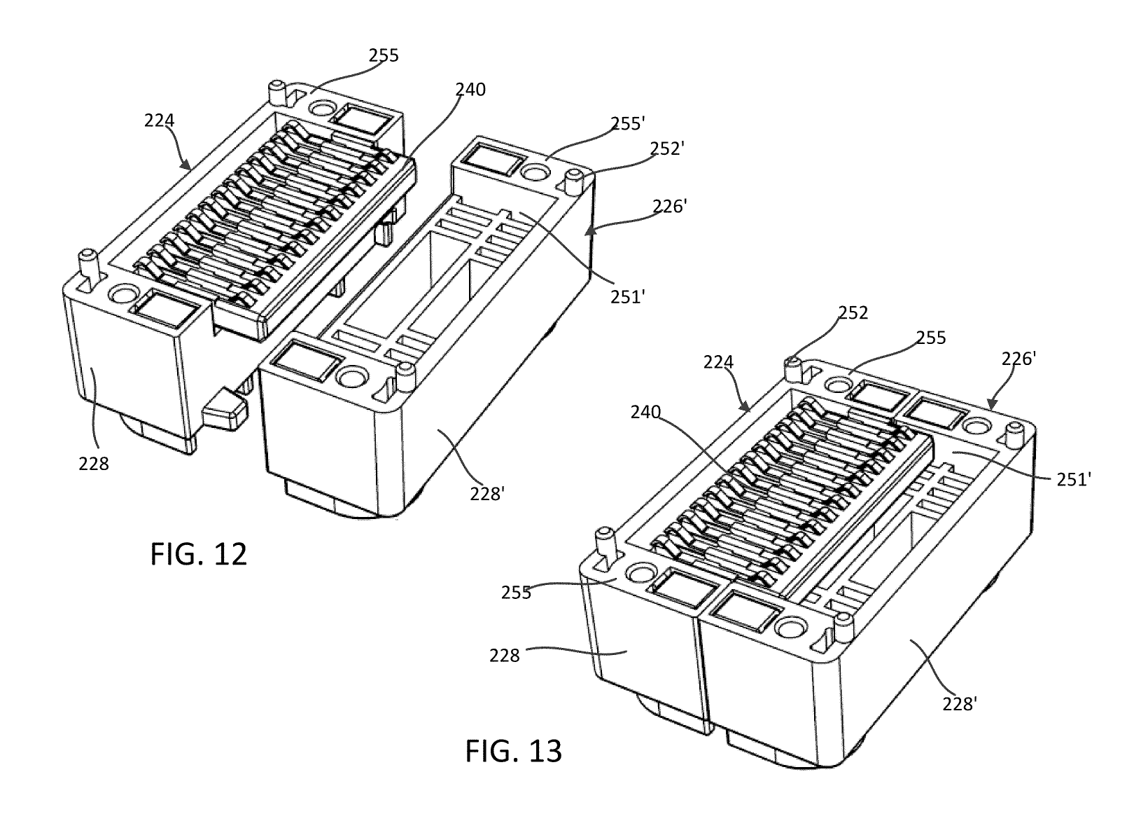

The connector 226 of the module 220 does not include a contact assembly permanently or fixedly coupled thereto. Thus, for a given module 220, the module 220 will have a connector 224 that has a contact assembly 240 fixedly or permanently coupled thereto and a connector 226 that does not have a contact assembly 240 fixedly or permanently coupled thereto. For the connector 226, the circuit board 222 is coupled to the housing 228 of the connector 226 in the same manner as the circuit board 222 is coupled to the housing 228 of connector 224. Without a contact assembly, a front opening 242 in communication with the interior region 251 is defined between the circuit board 222 and the housing 228 of connector 226, as shown, for example, in FIG. 6. The opening 242 and interior region 251 can receive a portion of a contact assembly 240 of another module 220 when the connector 226 of the module 220 is coupled to that other module 220. Thus, when a first module 220 is removably coupled to a second module 220 by coupling a connector 224 of the first module 220 to a connector 226 of the second module 220, the contact assembly 240 coupled to the connector 224 can be received in a lateral direction through the opening 242 and within the interior region 251, and can engage the circuit board 222 of the second module 220. The contact assembly 240 can then carry a signal from the circuit board 222 of the first module 220 to the circuit board 222 of the second module 220. FIGS. 12 and 13 illustrate the connector 224 of module 220 with the circuit board 222 removed (for illustrative purposes) and a connector 226′ of another module 220′, shown uncoupled and coupled, respectively. As shown in FIG. 13, when the connector 224 is removably coupled to the connector 226′, the contact assembly 240 is received within the interior region 251′ of the connector 226′. Further, the connector 224 is magnetically coupled to the connector 226′ via the magnets 250 of both the connector 224 and the connector 226′, and the protrusion 232 of connector 224 is received within a recess (not shown in FIGS. 12 and 13) of the connector 226′ and the recess 234 of connector 224 receives a corresponding protrusion (not shown in FIGS. 12 and 13) of the connector 226′.

As described above for the previous embodiment, the module 220 can also be used or interconnected with a component of a different building block system, such as a LEGO® block system. More specifically, each connector 224, 226 includes mounting portions 230 that can be used to removably couple the module 220 to such a component of a different building block system (see, e.g., FIG. 17 illustrating modules 320, 320′ coupled to a LEGO® block). In this embodiment, the mounting portion 230 is substantially u-shaped and defines a recessed area, as best shown in the bottom view of FIG. 3. The recessed area of the mounting portions 230 can matingly couple to, for example, a protrusion or post of a LEGO® block (see, e.g., modules 320 and 320′ in FIG. 17) to removably couple the module 220 to the LEGO® block.

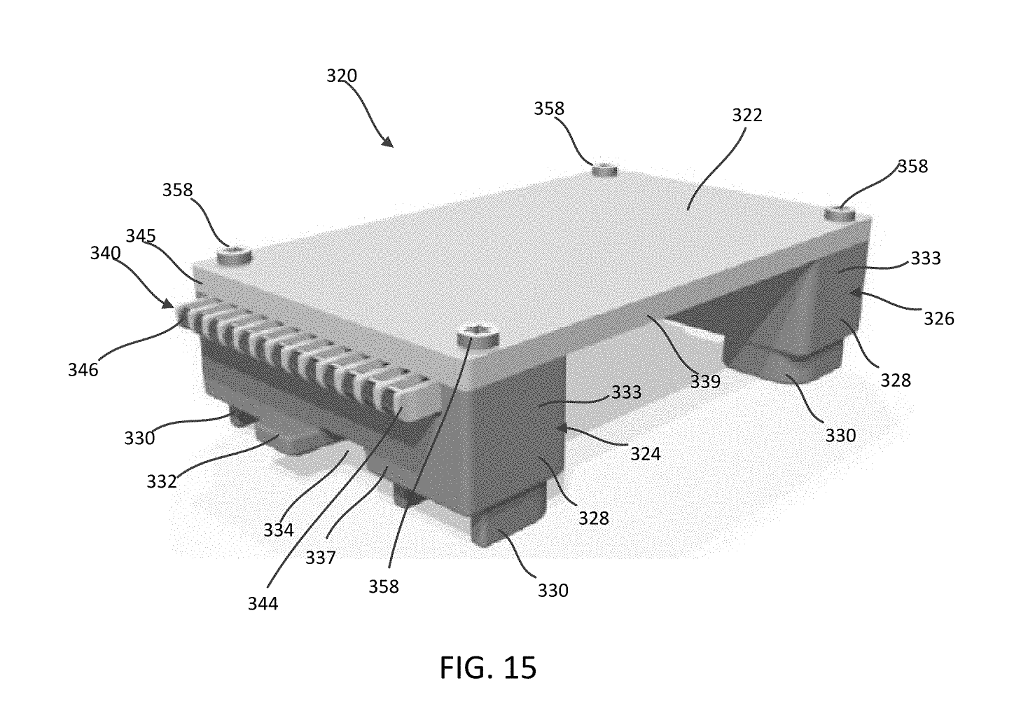

FIGS. 15-17 illustrate components of another embodiment of a modular electronic building system. A modular electronic building block system 300 (also referred to herein as “system”, “block system” or “electronic building block system” or “electronic building system”) can include one or more electronic modules 320 (also referred to herein as “modules,” “blocks,” or “electronic blocks”) that can each be removably coupled to at least one other module 320 (see FIG. 17 illustrating two modules 320 and 320′ coupled together).

The modules 320 can include the same or similar features and can provide the same or similar function(s) as described above for modules 120 and 220, and each module 320 of system 300 can be coupled to another module 320 in the same manner as described for module 220. Thus, some details of the module 320 are not described herein. Further, although not shown in FIGS. 15-17, the modules 320 of the system 300 can each include one or more electrical components (e.g., electrical components 135) as described above for system 100 that can each provide that module 320 with a particular functionality, and include various categories and types of modules as described above. For example, the system 300 can include a power module 320 and when the power module 320 is removably coupled to another module 320 having an electrical component, the power module 320 can provide power to that other module 320.

The module 320 includes a printed circuit board 322 (also referred to as “PCB” or “circuit board”) coupled to a first connector 324 and a second connector 326. The circuit board 322 can have the same or similar structure and function as the circuit boards 122 and 222 described above.

The connectors 324 and 326 can also be the same as or similar to the connectors 224, 226 described above. For example, each connector 324 and 326 includes a common housing 328 that can be fixedly or permanently coupled to the circuit board 322 with, for example, a mechanical fastener (e.g., bolt, screw, rivet, etc.) 358. For example, as described above for module 220, the circuit board 322 can include or define openings (not shown) and the connectors 324 and 326 can each define corresponding openings (not shown) that can receive the fastener 358 therethrough to secure the circuit board 322 to the connectors 324 and 326. The circuit board 322 can also define openings (not shown) that can receive a locating pin (not shown) of the connectors 324 and 326 as described above for module 220.

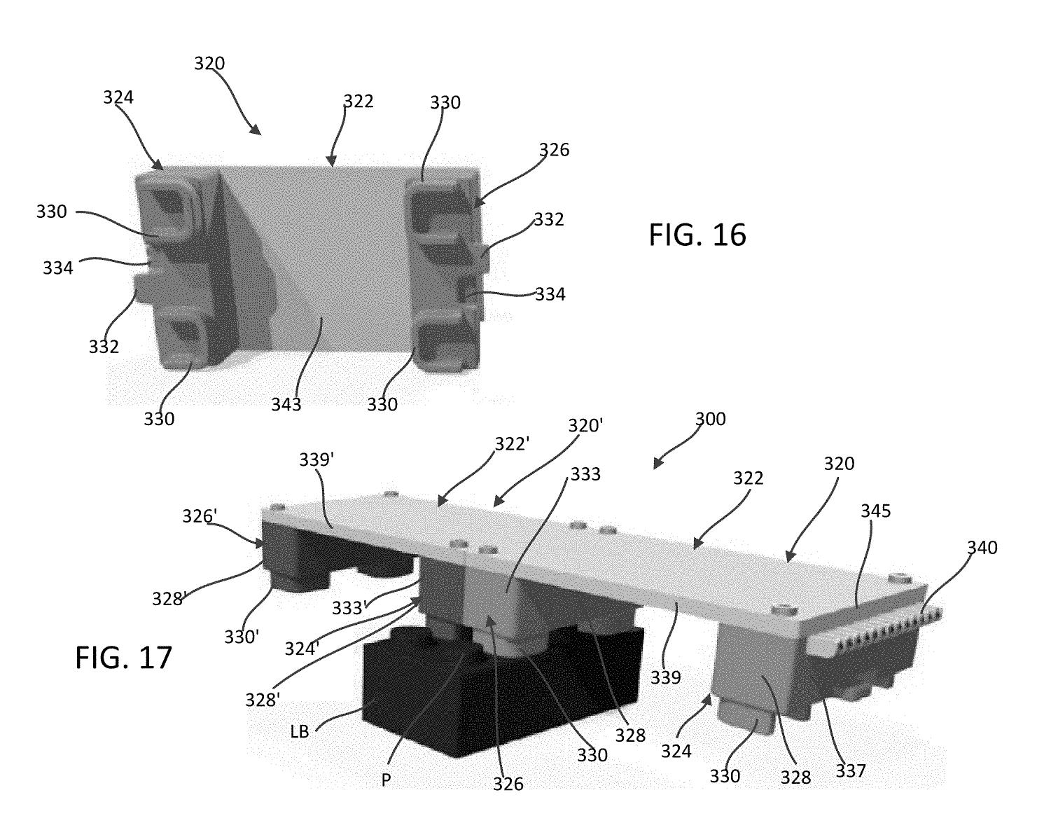

As with previous embodiments, the circuit board 322 is coupled to the connectors 324 and 326 such that a bottom surface 343 (see, e.g., FIG. 16) of the circuit board 322 contacts a top surface (not shown) of the housing 328 of each of the connectors 324 and 326. When coupled to the circuit board 322, the connectors 324 and 326 are disposed below or beneath the circuit board 322. In addition, a side surface 339 of the circuit board 322 is aligned or substantially aligned with a side surface 333 of the housing 328 of the connectors 324 and 326, and a front or end surface 345 of the circuit board 322 is aligned or substantially aligned with the front surface 337 of the housing 328 of the connectors 324 and 326.

The common housing 328 defines two receptacles (not shown) that can each receive therein a magnet (not shown) that can be used to removably couple each of the connectors 324 and 326 to a connector of a different module 320 of the system 300. The magnets can be the same as or similar to and function the same as or similar to the magnets described above for modules 120 and 220. For example, with the magnets disposed within the receptacles, a magnetic force can be applied/transferred through a front surface 337 of the housing 328 of the connectors 324 and 326. Thus, the connectors 324 and 326 can each be removably coupled to another connector of another module 320 through magnetic force when the front surface 337 of the housing 328 of the connectors 324 and 326 engages/contacts a front surface of a housing of another connector (similarly constructed with magnets disposed within a receptacle). In other words, the connectors 324 and 326 will be magnetically coupled to the other connectors via magnetic force of the magnets.

The connectors 324 and 326 of the module 320 also include an interlocking coupling mechanism that includes a protrusion 332 and a recess 334 defined by the housing 328 that can interlock, mate, or complimentarily fit with a recess 334 and protrusion 332, respectively, of another connector of another module 320. The interlocking of the protrusions 332 and recesses 334 can inhibit two modules 320 from sliding laterally or side-to-side with respect to each other when removably coupled together. In this embodiment, the protrusion 332 is disposed next to or adjacent to the recess 334 as shown, for example, in FIGS. 15 and 16.

The connectors 324, 326 of the module 320 can each be coupled to a different connector of another module 320 with the magnets and the interlocking coupling mechanism (e.g., protrusion 332 and recess 334), which further help maintain the connectors of the different modules coupled together. When the module 320 is removably coupled to another module 320 via the magnets of the connectors 324 or 326, a front surface 337 of the housing 328 of the connectors 324, 326 of the module 320 contacts a front surface of the housing of the connector of the other module 320, as described above for previous embodiments. Further, when the module 320 is removably coupled to another module 320, a side surface 333 of the housing 328 of the connector 324 or 326 of the module 320 is aligned or substantially aligned with a side surface of the housing of the connector of the other module 320. For example, as shown in FIG. 17, the module 320 is removably coupled to the module 320′ and the side surface 333 of the housing 328 of connector 326 is aligned with the side surface 333′ of the housing 328′ of the connector 324′.

The module 320 further includes a contact assembly 340 that is permanently or fixedly coupled to the connector 324 and to the circuit board 322. The contact assembly 340 can be constructed the same as or similar to the contact assembly 240 and can include a base 344 and multiple electrical contacts or conductors 346 coupled to the base 344, as best shown in FIG. 15. The contacts 346 can be, for example, spring probes or small metal plate. In this embodiment, there are 13 contacts 346, but it should be understood that a different number of contacts 346 can be used. The contact assembly 340 can also include a mounting block (not shown in FIGS. 15-17) extending from a bottom surface of the base 344 that can be received within an interior region of the connector 324 as described above for contact assembly 240. The circuit board 322 can be coupled to the connector 324 in the same manner as described above for module 320 such that the contact assembly 340 is sandwiched between the housing 328 of connector 324 and the circuit board 322 and is maintained permanently coupled with a pressure fit. Further, when the circuit board 322 is coupled to the connectors 324, 326, the magnets are held or maintained within the receptacles of the housing 328. As shown, for example, in FIGS. 15 and 17, when the module 320 is assembled with the circuit board 322 coupled to the connectors 324 and 326, a portion of the contact assembly 340 extends outwardly from the front surface 337 of the housing 328 of connector 324.

As described for module 220, the connector 326 of the module 320 does not include a contact assembly fixedly or permanently coupled thereto. Thus, for a given module 320, the module 320 will have a connector 324 that has a contact assembly 340 permanently or fixedly coupled thereto and a module 326 that does not have a contact assembly 340 permanently or fixedly coupled thereto. For the connector 326, the circuit board 322 is coupled to the housing 328 of the connector 326 in the same manner as the circuit board 322 is coupled to the housing 328 of connector 324. Without a contact assembly, a front opening (not shown in FIGS. 15-17) in communication with an interior region (not shown in FIGS. 15-17) is defined between the circuit board 322 and the housing 328 of connector 326. The opening and interior region can receive a portion of a contact assembly 340 of another module 320 when the connector 326 of the module 320 is coupled to that other module 320. Thus, when a first module 320 is removably coupled to a second module 320, the contact assembly 340 coupled to the connector 324 can engage the circuit board 322 of the second module 320 and carry a signal from the circuit board 322 of the first module 320 to the circuit board 322 of the second module 320.

As described above for the previous embodiments, the module 320 can also be used or interconnected with a component of a different building block system, such as a LEGO® block system. More specifically, each connector 324, 326 includes mounting portions 330 that can be used to removably couple the module 320 to such a component of a different building block system (see, e.g., FIG. 17 illustrating modules 320, 320′ coupled to a LEGO° block 315). In this embodiment, the mounting portion 330 is substantially u-shaped and defines a recessed area, as best shown in the bottom view of FIG. 16. The recessed area of the mounting portions 330 can matingly couple to, for example, a protrusion or post P of a LEGO® block LB as shown in in FIG. 17) to removably couple the modules 320, 320′ to the LEGO® block LB.

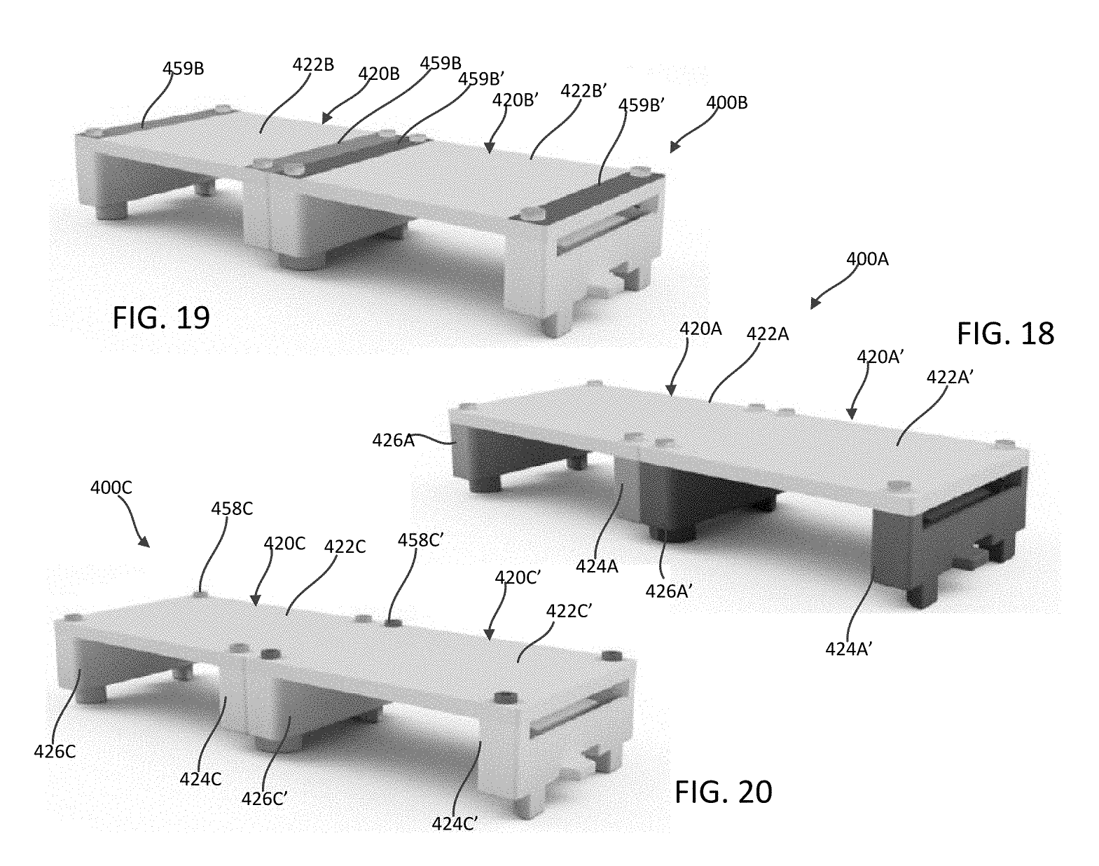

As described above, each module of a system as described herein may be uniquely configured to provide a quick visual indication to a user of each module's function. FIGS. 18-20 illustrate example modules with such visual indicators. FIG. 18 illustrates a system 400A with modules 420A and 420A′ coupled together. The modules 420A, 420A′ include a circuit board 422A, 422A′, male connectors 424A, 424A′ with contact assemblies (not shown), and female connectors 426A, 426A′. In this embodiment, the connectors 424A, 424A′ and 426A, 426A′ are color coded to indicate a different type of module. For example, the connectors 424A and 426A can be a first color (e.g., green) and the connectors 424A′ and 426′ can be a second color (e.g., pink). The first color can indicate, for example, a power module, and the second color can indicate an input module such as a module having a switch.

FIG. 19 illustrates a system 400B with modules 420B and 420B′ coupled together. The modules 420B, 420B′ include a circuit board 422B, 422B′, male connectors 424B, 424B′ with contact assemblies (not shown), and female connectors 426B, 426B′. In this embodiment, the modules 420B, 420B′ each includes two indicator strips 459B, 459B′ attached to the circuit boards 422B, 422B′ that can indicate a different type of module. For example, the indicator strips 459B of module 420B can be a first color (e.g., green) and the indicator strips 459B′ of module 420B′ can be a second color (e.g., pink). The first color can indicate, for example, a power module, and the second color can indicate an input module such as a module having a switch.

FIG. 20 illustrates a system 400C with modules 420C and 420C′ coupled together. The modules 420C, 420C′ include a circuit board 422C, 422C′, male connectors 424C, 424C′ with contact assemblies (not shown), and female connectors 426C, 426C′. In this embodiment, the fasteners 458C, 458C′ used to couple the circuit boards 422C, 422C′ to the connectors 424C, 424C′, 426C, 426C′, can be color-coded. For example, the fasteners 458C of module 420C can be a first color (e.g., green) and the fasteners 458′ of module 420C′ can be a second color (e.g., pink). The first color can indicate, for example, a power module, and the second color can indicate an input module such as a module having a switch.

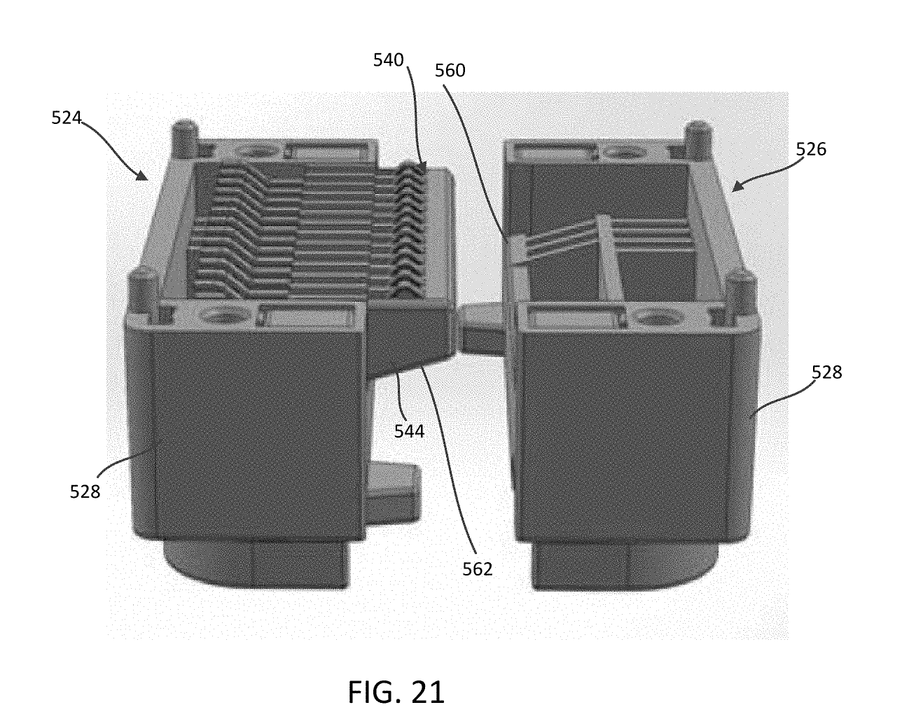

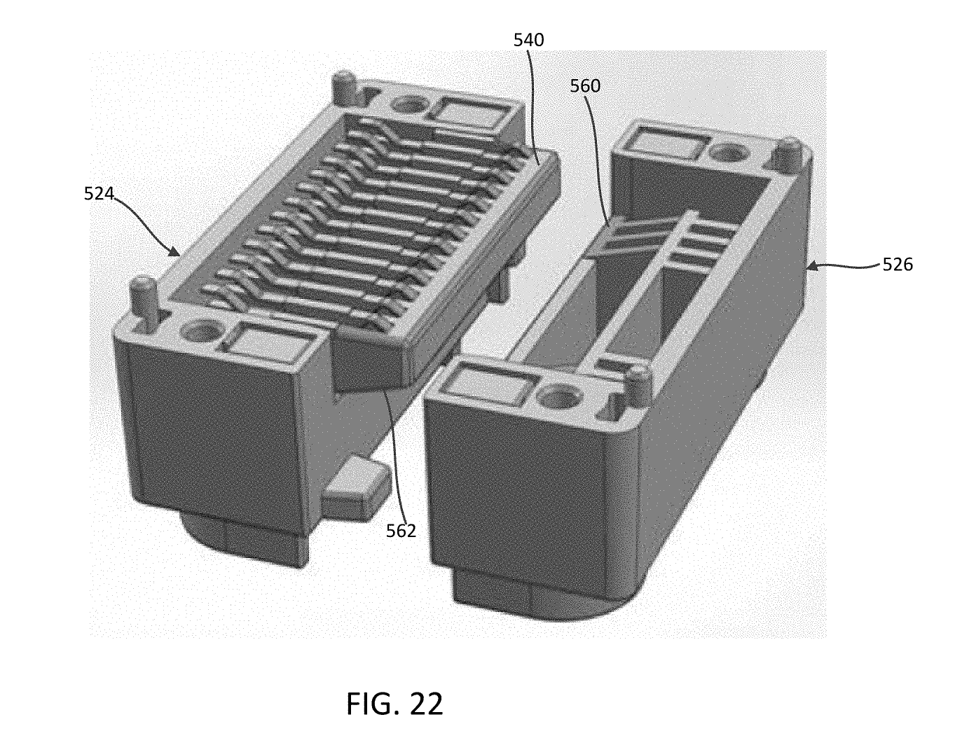

FIGS. 21 and 22 illustrate alternative embodiments of connectors 524 and 526 and of a contact assembly 540 that can be included in any of the embodiments of a module described herein. Other features of the connectors 524, 526 and contact assembly 540 can be the same or similar to previously described embodiments. The connectors 524 and 526 have a common housing 528 with an interior region 541, as described for previous embodiments. In this embodiment, the housing 528 includes a ramped or angled surface 560 within the interior region 541, and the contact assembly 540 includes a base 562 that has a bottom angled surface 562. The bottom angled surface 562 of the contact assembly 540 can matingly engage the angled surface 560 of the housing 528 of connectors 524, 526. The angled surfaces 560, 562 can help guide the insertion of the contact assembly 540 of one module into the interior region 541 of a second module when being coupled together as described herein.

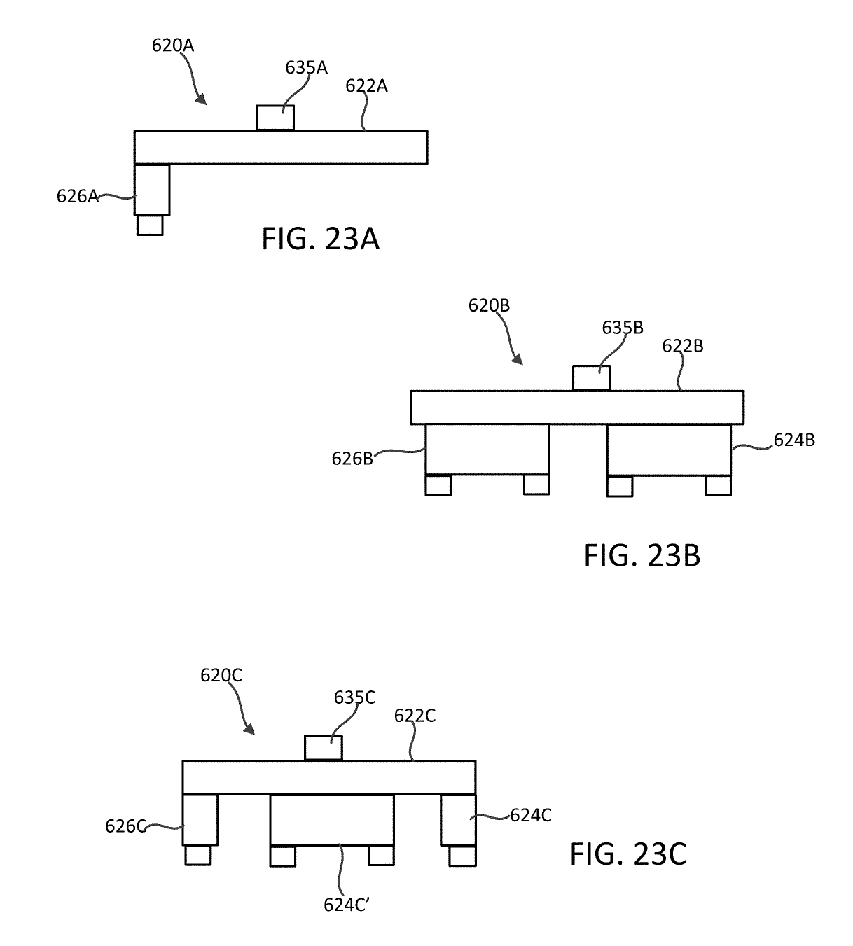

Although embodiments of modules (e.g., 120, 220, etc.) are shown and described as having a connector (e.g., connectors 124 and 126) coupled to one end or two opposite ends or edges of a circuit board (e.g., circuit boards 122), in other embodiments, a module can include connectors coupled to more than two ends or edges of a circuit board. For example, FIGS. 23A-23C are each a schematic illustration of a side view of a module including a circuit board and one or more connectors. The modules of FIGS. 23A-23C can include various different embodiments of a connector and/or circuit board as described herein.

FIG. 23A illustrates a module 620A including a circuit board 622A, one connector 626A coupled to a single edge or end portion of the circuit board 622A and an electronic component 635A. FIG. 23B illustrates a module 620B including a circuit board 622B, two connectors 624B and 626B coupled to a single edge or end portion of the circuit board 622B, and an electronic component 635B. FIG. 23C illustrates a module 620C including a circuit board 622C, three connectors 624C, 624C′, 626C coupled to three different edges or end portions of the circuit board 622C, and an electronic component 635C. The module 620C can also include a fourth connector, e.g., a connector 626C′ (not shown in the side view) on the opposite side of the circuit board 622C as connector 624C′.

Although not shown, for any of the electronic building block systems described herein an adapter(s) or foot member can be included to adjust the height of a connector (e.g., 124, 126, 224, 226, etc.). For example, an adapter can be coupled to a bottom portion of a connector to increase a length or height of the connector. Such adapters can be, for example, adhesively coupled to a bottom portion of the connector. In some embodiments, the adapter can include a mounting member or portion similar to the mounting portions (e.g., 130, 230, etc.) described above, such that the adapter can engage complementarily shaped components of a different building block system such as a LEGO® block.

As described herein, modules of an electronic building block system are adapted to have a variety of different types of functionality and to include the appropriate connectors, circuit boards, and associated electrical components coupled to the circuit boards to perform the desired functionality. The modules shown in the illustrated embodiments are for exemplary and demonstrative purposes, and are not intended to be limiting.

It should be understood that the structures, features, functionality, and other characteristics of the various example embodiments of the systems disclosed herein and illustrated in FIGS. 1-23C may be combined with each other in any manner and in any combination or sub-combination and all such manners and combinations are intended to be within the spirit and scope of the present invention.

As described above in the many examples of modules and systems, numerous modules may be coupled together to achieve various functionalities of the systems. Modules may be coupled in a cascading manner in which the inclusion of one module in the system may affect the functionality of downstream modules in a first manner and inclusion of a different module in the system may affect the function of downstream modules in another manner different than the first manner. That is, modules coupled together in a system may have dependencies upon one another to affect functionality thereof and of the entire system. A simple example to demonstrate this concept, but is not intended to be limiting, includes a system having three modules, for example, a power module, a button module, and an LED module. The button module and the LED module are dependent on the power module, and the LED module is dependent on the button module. To demonstrate the dependency of the button module and the LED module on the power module, if the power module is not providing any power, then neither the button module nor the LED module can operate in their intended manner. Similarly, to demonstrate the dependency of the LED module on the button module, in some embodiments, if the button is not depressed or otherwise activated to close the circuit, the LED module will not be illuminated, and if the button is depressed, the LED module will be illuminated. In other words, cascading modules in a system affect operation and functionality of downstream modules. In some embodiments, if the button is not disposed between the LED and power module, the LED will illuminate and the button will have no function.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components, and/or features of the different embodiments described.

Where methods described above indicate certain events occurring in certain order, the ordering of certain events may be modified. Additionally, certain of the events may be performed concurrently in a parallel process when possible, as well as performed sequentially as described above.

In addition to the previously described exemplary connectors, many modifications to the connectors are possible, including, but not limited to, the housing of a connector, the type of conductors or contacts used, the number of conductors or contacts, as well as the number of magnets, the shape of the magnets, the polarity of the magnets, the manner in which the connectors are couple to the circuit board of the module, etc.

1. An apparatus, comprising:
a first connector including a housing having a top surface and a bottom surface opposite the top surface, the housing defining a receptacle between the top surface of the housing and the bottom surface of the housing, the receptacle having a first end open at the top surface and a second end opposite the first end of the receptacle, the second end of the receptacle being closed;
a magnet disposed within the receptacle; and
a circuit board having a top surface and a bottom surface opposite the top surface, the circuit board permanently coupled to the first connector such that the bottom surface of the circuit board contacts the top surface of the housing of the first connector and the circuit board covers the first end of the receptacle preventing the magnet from being removed from the receptacle,
the first connector configured to be removably coupled to a second connector such that a front surface of the housing of the first connector engages a front surface of a housing of the second connector and the magnet disposed within the receptacle of the housing of the first connector magnetically couples to a magnet of the second connector.

2. The apparatus of claim 1, wherein the first connector includes a protrusion and a recess, the protrusion configured to be received within a recess of the second connector and the recess configured to receive a protrusion of the second connector when the first connector is removably coupled to the second connector.

3. The apparatus of claim 1, wherein the circuit board is a first circuit board, the apparatus further comprising:
a contact assembly permanently coupled to the first connector and disposed at least partially between the housing of the first connector and the first circuit board, the contact assembly configured to electrically engage a second circuit board coupled to the second connector when the first connector is coupled to the second connector.

4. The apparatus of claim 3, wherein the contact assembly has a top surface and a bottom surface opposite of and angled relative to the top surface of the contact assembly, the housing of the second connector has a mating angled surface such that when the first connector is removably coupled to the second connector, the angled bottom surface of the contact assembly matingly engages the angled surface of the housing of the second connector.

5. The apparatus of claim 3, wherein:
the circuit board is a first circuit board,
the housing of the second connector is coupled to a second circuit board such that an interior region is defined between a portion of the housing of the second connector and a bottom surface of the second circuit board,
at least a portion of the contact assembly is configured to be received within the interior region and electrically engage the second circuit board when the first connector is removably coupled to the second connector.

6. The apparatus of claim 5, wherein the at least a portion of the contact assembly is slidably received in a lateral direction within the interior region such that a top portion of at least one contact of the contact assembly slidably engages at least one contact on the second circuit board.

7. The apparatus of claim 1, wherein the second connector does not include a permanently connected contact assembly.

8. The apparatus of claim 3, wherein the first circuit board is permanently coupled to the first connector such that the contact assembly disposed at least partially between the housing of the first connector and the first circuit board is maintained permanently coupled to the first connector with a pressure-fit.

9. An apparatus, comprising:
a first connector including a housing having a top surface and a bottom surface opposite the top surface;
a contact assembly coupled to the first connector; and
a first circuit board having a top surface and a bottom surface opposite the top surface, the first circuit board coupled to the first connector such that the bottom surface of the first circuit board contacts the top surface of the housing of the first connector and at least a portion of the contact assembly is disposed between the bottom surface of the first circuit board and a portion of the housing of the first connector,
the first connector configured to be removably coupled to a second connector such that a front surface of the housing of the first connector engages a front surface of a housing of the second connector and at least a portion of the contact assembly is received within an interior region defined between the housing of the second connector and a second circuit board coupled to the housing of the second connector and at least one contact of the contact assembly electrically and directly engages at least one contact of the second circuit board.

10. The apparatus of claim 9, wherein the first connector includes a protrusion and a recess, the protrusion of the first connector configured to be received within a recess of the second connector and the recess of the first connector configured to receive a protrusion of the second connector, when the first connector is removably coupled to the second connector.

11. The apparatus of claim 9, wherein the contact assembly has a top surface and a bottom surface opposite of and angled relative to the top surface of the contact assembly, the housing of the second connector has an angled surface such that when the first connector is removably coupled to the second connector, the angled bottom surface of the contact assembly matingly engages the angled surface of the housing of the second connector.

12. The apparatus of claim 9, wherein the first connector is configured to be removably coupled to the second connector such that the at least a portion of the contact assembly is slidably received in a lateral direction within the interior region such that a top portion of at least one contact of the contact assembly slidably engages at least one contact on the second circuit board.

13. The apparatus of claim 9, wherein the second connector does not include a permanently connected contact assembly.

14. The apparatus of claim 9, wherein the contact assembly is permanently coupled to the first circuit board without a solder connection between contacts of the contact assembly and the first circuit board.

15. The apparatus of claim 9, wherein the first circuit board is permanently coupled to the first connector such that the contact assembly is maintained permanently coupled to the first connector with a pressure fit.

16. The apparatus of claim 9, wherein the contact assembly coupled to the first connector includes a contact having a first end portion and a second end portion, the first end portion is movable from a first position in which the first end portion is biased in a first vertical direction to a second position in which the first end portion is moved in a second vertical direction opposite the first vertical direction when the circuit board is coupled to the first connector,
the second end portion is movable from a first position in which the second end portion is biased in a first vertical direction to a second position in which the second end portion is moved in a second vertical direction opposite the first vertical direction when the first connector is removably coupled to the second connector.

17. An apparatus, comprising:
a first connector including a first housing having a top surface and a bottom surface opposite the top surface;
a contact assembly permanently coupled to the first housing of the first connector;
a first circuit board having a top surface and a bottom surface opposite the top surface, the first circuit board permanently coupled to the first connector such that at least a portion of the bottom surface of the first circuit board contacts at least a portion of the top surface of the first housing of the first connector and at least a portion of the contact assembly is disposed between the bottom surface of the first circuit board and at least a portion of the first housing;
a second connector including a second housing having a top surface and a bottom surface opposite the top surface of the second housing; and
the first circuit board permanently coupled to the second housing of the second connector such that an interior region is defined between a portion of the bottom surface of the first circuit board and a portion of the second housing of the second connector,
the contact assembly of the first connector configured to be received within an interior region defined between a third connector and a second circuit board coupled to the third connector,
the interior region defined between the second housing of the second connector and the second circuit board configured to receive a portion of a contact assembly coupled to a fourth connector and a third circuit board coupled to the fourth connector.

18. The apparatus of claim 17, wherein the second connector does not include a permanently connected contact assembly.

19. The apparatus of claim 17, wherein a form factor of the first housing of the first connector substantially corresponds to a form factor of the second housing of the second connector.

20. The apparatus of claim 17, wherein the first circuit board is permanently coupled to the first housing of the first connector and permanently coupled to the second housing of the second connector such that the contact assembly is maintained permanently coupled to the first housing of the first connector with a pressure fit.

21. The apparatus of claim 17, wherein:
the first housing of the first connector includes a first protrusion and a first recess, the second housing of the second connector includes a second protrusion and a second recess,
the first protrusion configured to be received within a third recess of the third connector and the first recess configured to receive a third protrusion of the third connector, when the first connector is removably coupled to the third connector,
the second protrusion configured to be received within a fourth recess of the fourth connector and the second recess configured to receive a fourth protrusion of the fourth connector, when the second connector is removably coupled to the fourth connector.

22. The apparatus of claim 17, wherein the first housing of the first connector defines a receptacle between the top surface of the first housing and the bottom surface of the first housing, the receptacle having a first end open at the top surface of the first housing of the first connector and a second end opposite the first end of the receptacle, the second end of the receptacle being closed, the apparatus further comprising:
a magnet disposed within the receptacle, the first circuit board being coupled to the first housing of the first connector such that the first circuit board covers the first end of the receptacle preventing the magnet from being removed from the receptacle,
when the first connector is coupled to the third connector, at least a portion of the front surface of the first connector engages at least a portion of a front surface of the third connector and the magnet disposed within the receptacle magnetically couples to a magnet of the third connector.

23. The apparatus of claim 22, wherein the receptacle is a first receptacle, the magnet is a first magnet, the second housing of the second connector defines a second receptacle between the top surface of the second housing and the bottom surface of the second housing, the second receptacle having a first end open at the top surface of the second housing and a second end opposite the first end of the second receptacle, the second end of the second receptacle being closed, the apparatus further comprising:
a second magnet disposed within the second receptacle, the first circuit board being coupled to the second housing of the second connector such that the first circuit board covers the first end of the second receptacle preventing the second magnet from being removed from the second receptacle,
when the second connector is coupled to the fourth connector, at least a portion of the front surface of the second connector engages at least a portion of a front surface of the fourth connector and the second magnet disposed within the second receptacle magnetically couples to a magnet of the fourth connector.
